(19) United States
(12) Patent Application Publication
(10) Pub. No.: US 2026/0136159 A1
(43) Pub. Date: May 14, 2026

(54) COMMUNICATION METHOD AND APPARATUS

(71) Applicant: HUAWEI TECHNOLOGIES CO., LTD., Shenzhen (CN)

(72) Inventors: Haifeng Yu, Shenzhen (CN); Bingzhao Li, Beijing (CN); Jinhuan Xia, Beijing (CN)

(21) Appl. No.: 19/444,922

(22) Filed: Jan. 9, 2026

Related U.S. Application Data
(63) Continuation of application No. 17/867,234, filed on Jul. 18, 2022, now Pat. No. 12,556,888.
Application No. 17/867,234 is a continuation of application No. PCT/CN2020/073326, filed on Jan. 20, 2020.

(51) Int. Cl. H04W 4/06; H04L 27/26; H04W 72/0446; H04W 72/23

(52) U.S. Cl. CPC H04W 4/06; H04L 27/26025; H04W 72/0446; H04W 72/23

(57) ABSTRACT

This application discloses a communication method and apparatus. The method includes: A network device sends multicast configuration information to a terminal device, where the multicast configuration information corresponds to a first multicast service, the multicast configuration information includes first indication information, and the first indication information indicates that the terminal device needs to send first feedback information for the first multicast service. The terminal device receives the first multicast service based on the first multicast configuration information, and then sends the first feedback information corresponding to the first multicast service to the network device based on the first indication information in the first multicast configuration information. The method and the apparatus in this application may be used to implement a feedback mechanism applicable to a multicast transmission technology and improve transmission reliability of a multicast service.

### CROSS-REFERENCE TO RELATED APPLICATIONS

This application is a continuation of U.S. patent application Ser. No. 17/867,234, filed on Jul. 18, 2022, which is a continuation of International Application No. PCT/CN2020/073326, filed on Jan. 20, 2020. All of the aforementioned patent applications are hereby incorporated by reference in their entireties.

### TECHNICAL FIELD

This application relates to the field of communication technologies, and in particular, to a communication method and apparatus.

### BACKGROUND

In a wireless communication system, a multicast transmission technology can support point-to-multipoint communication, that is, a network device transmits same data to a plurality of terminal devices. A multicast transmission service may be, for example, a mobile television service. Currently, there are two broadcast multicast service modes in a long term evolution (long term evolution, LTE) communication system: a multimedia broadcast multicast service (multimedia broadcast multicast service, MBMS) mode and a single-cell point-to-multipoint (single-cell point-to-multipoint, SC-PTM) mode. When the multicast transmission technology is used to transmit a multicast service, a terminal device needs to first obtain multicast configuration information, and then receive the multicast service based on the multicast configuration information.

However, currently, the multicast transmission technology does not support hybrid automatic repeat request (hybrid automatic repeat request, HARQ) feedback. Consequently, reliability is low, and reliability requirements of a part of multicast services cannot be met when the multicast transmission technology is applied to a new radio access technology (new radio access technology, NR).

### SUMMARY

This application provides a communication method and apparatus, to implement a feedback mechanism applicable to multicast transmission, and improve transmission reliability of a multicast service.

According to a first aspect, an embodiment of this application provides a communication method. The method may be applied to a terminal device, or may be applied to a chip inside the terminal device. That the method is applied to the terminal device is used as an example. In the method, the terminal device receives first multicast configuration information from a network device, where the first multicast configuration information is for indicating to send first feedback information for a first multicast service, the first multicast configuration information corresponds to the first multicast service, the first multicast configuration information includes first indication information, and the first indication information is for indicating to send the first feedback information for the first multicast service. Further, the terminal device receives the first multicast service from the network device, and sends the first feedback information to the network device.

In this solution, in an aspect, the terminal device may provide a feedback for the multicast service; in another aspect, because the first indication information indicates to provide a feedback for the first multicast service, the terminal device may provide a feedback for the multicast service that has a high latency requirement and that is indicated by the network device, so that reliability of the multicast service with the high latency requirement can be effectively improved.

In a possible design, the first multicast configuration information further includes a group radio network temporary identifier (group radio network temporary identifier, G-RNTI) and/or a multicast service identifier that are/is associated with the first multicast service, and the G-RNTI and/or the multicast service identifier are/is associated with the first indication information.

In this way, because the first indication information is included in the first multicast configuration information, the first indication information does not need to be separately sent, so that transmission resources can be effectively reduced.

In a possible design, the first indication information indicates, by using a bit or a field, to provide a feedback for the first multicast service.

In this way, after receiving the first indication information, the terminal device can determine that the terminal device needs to provide a feedback for the first multicast service.

In a possible design, the first indication information is for indicating a transmission resource of the first feedback information.

In this way, in an aspect, after receiving the first indication information, the terminal device can determine that the terminal device needs to provide a feedback for the first multicast service; in another aspect, the network device implicitly indicates transmission resource information of the terminal device by using downlink control information, so that transmission resources can be effectively reduced.

In a possible design, the first indication information may include a signal quality parameter threshold, and the terminal device determines, based on the signal quality parameter threshold, whether the feedback information needs to be sent. Specifically, after receiving the first indication information, the terminal device sends the first feedback information to the network device only when determining that a value of a signal quality parameter corresponding to the first multicast service is less than or equal to the threshold. Otherwise, the terminal device does not send the first feedback information.

In this way, the terminal device can autonomously determine, based on a specific receiving status of the multicast service, whether to provide a feedback.

In a possible design, the terminal device may further receive second multicast configuration information from the network device, where the second multicast configuration information corresponds to a second multicast service, the second multicast configuration information includes second indication information, and the second indication information is for indicating that the terminal device does not need to send feedback information for the second multicast service. In this way, after receiving the second multicast service, the terminal device does not provide a feedback.

In this way, the terminal device may provide a feedback for only the service with the high latency requirement, so that information transmission reliability is improved, and transmission resources can be reduced.

In a possible design, when a feedback resource of the first multicast service conflicts with a feedback resource of a unicast service, the terminal device may determine, based on a priority of feedback information, whether to send the first feedback information of the first multicast service to the network device. Specifically, if it is agreed on in advance in a protocol that a priority of feedback information of a multicast service is higher than a priority of feedback information of a unicast service, the terminal device may preferentially send the first feedback information corresponding to the first multicast service to the network device, and discard feedback information corresponding to the unicast service. If it is agreed on in advance in a protocol that a priority of feedback information of a multicast service is not higher than a priority of feedback information of a unicast service, the terminal device preferentially sends feedback information corresponding to the unicast service to the network device, and discards the first feedback information corresponding to the first multicast service.

In this way, the terminal device may provide a feedback for the unicast service or the multicast service based on a protocol agreement, to resolve a resource conflict problem.

In a possible design, the terminal device may further receive third indication information from the network device, where the indication information is for indicating a priority of the feedback information of the multicast service. The third indication information may be carried together with the multicast configuration information in downlink control information (downlink control information, DCI) or a radio resource control (radio resource control, RRC) message. In response to the third indication information, if the third indication information indicates that the priority of the feedback information of the first multicast service is a first priority (for example, a high-level priority), the terminal device preferentially sends the first feedback information corresponding to the first multicast service to the network device, and discards feedback information corresponding to the unicast service. If the third indication information indicates that the priority of the feedback information of the first multicast service is a second priority (for example, a low-level priority), the terminal device preferentially sends feedback information corresponding to the unicast service to the network device, and discards the first feedback information corresponding to the first multicast service.

In this way, the terminal device may provide a feedback for the unicast service or the multicast service based on an indication of the network device, to resolve the resource conflict problem.

In a possible design, the network device sends fourth indication information to the terminal device, where the fourth indication information is for triggering the terminal device to send feedback stopping acknowledgment information to the network device. Because the terminal device receives the fourth indication information, the terminal device is triggered to send the feedback stopping acknowledgment information to the network device. In this way, the terminal device can stop, in a timely manner based on an indication of the network device, providing a feedback for the first multicast service. The terminal device releases a PUCCH resource configured for multicast feedback, so that resource utilization is improved. In a possible manner, the fourth indication information may be carried in DCI, an RRC message, or a media access control (media access control, MAC) control element (control element, CE).

In a possible design, the feedback stopping acknowledgment information may be in a MAC sub-protocol data unit (protocol data unit, PDU), where the MAC sub-PDU includes a MAC subheader and a MAC CE, and the MAC subheader includes a logical channel identifier (logical channel identifier, LCID). In a possible manner, the feedback stopping acknowledgment information may be indicated by the logical channel identifier LCID. For example, if the LCID takes a preset value (for example, the value of the LCID is 33), it indicates that the terminal device stops sending the feedback information for the first multicast service. In another possible manner, the feedback stopping acknowledgment information may be indicated by a length of the MAC CE. For example, if the length of the MAC CE is a preset length, the MAC CE with the preset length is for indicating that sending of the feedback information for the first multicast service is stopped. In still another possible manner, the feedback stopping acknowledgment information may be indicated by the multicast service identifier or the G-RNTI in the MAC CE.

According to a second aspect, an embodiment of this application provides a communication method. The method may be applied to a network device, or may be applied to a chip inside the network device. That the method is applied to the network device is used as an example. In the method, the network device may send first multicast configuration information to a terminal device, where the first multicast configuration information corresponds to a first multicast service, the first multicast configuration information includes first indication information, and the first indication information is for indicating to send first feedback information for the first multicast service. Then, the network device sends the first multicast service to the terminal device, and receives the first feedback information from the terminal device.

The communication method described in the second aspect corresponds to the communication method described in the first aspect. Therefore, for related beneficial effects of the communication method described in the second aspect, refer to the first aspect. Details are not described herein again.

In a possible design, the first multicast configuration information further includes a group radio network temporary identifier G-RNTI and/or a multicast service identifier that are/is associated with the first multicast service, and the G-RNTI and/or the multicast service identifier are/is associated with the first indication information.

In a possible design, the first indication information indicates, by using a bit or a field, to provide a feedback for the first multicast service; and/or the first indication information is for indicating a transmission resource of the first feedback information.

In a possible design, the network device determines, based on at least one of a service requirement of the first multicast service, a physical relative distance between the terminal device and the network device, and channel quality of the terminal device, the terminal device that needs to send the feedback information for the first multicast service.

In a possible design, the network device sends second multicast configuration information to the terminal device, where the second multicast configuration information corresponds to a second multicast service, the second multicast configuration information includes second indication information, and the second indication information is for indicating that the terminal device does not need to send feedback information for the second multicast service.

In a possible design, before receiving the first feedback information from the terminal device, the network device sends third indication information to the terminal device, where the third indication information is for indicating a priority of the feedback information of the first multicast service. The third indication information is carried in downlink control information DCI, and the DCI is for scheduling a physical downlink shared channel PDSCH that carries the first multicast service.

In a possible design, the network device sends fourth indication information to the terminal device, where the fourth indication information is for indicating the terminal device to stop sending the feedback information for the first multicast service; and
receives feedback stopping acknowledgment information from the terminal device, where the feedback stopping acknowledgment information is for indicating that the terminal device stops sending the feedback information for the first multicast service.

In a possible design, the feedback stopping acknowledgment information is indicated by a logical channel identifier LCID, and the LCID is carried in a media access control MAC subheader; or the feedback stopping acknowledgment information is indicated by fifth indication information in a MAC control element CE; or the feedback stopping acknowledgment information is indicated by a length of a MAC CE.

In a possible design, the network device receives feedback capability information from the terminal device, where the feedback capability information is for indicating a capability of sending unicast feedback information and multicast feedback information on a same feedback resource by the terminal device, the unicast feedback information is feedback information corresponding to a unicast service, and the multicast feedback information is feedback information corresponding to a multicast service.

According to a third aspect, an embodiment of this application provides a first communication apparatus. The first communication apparatus is configured to perform the method according to any one of the first aspect or the possible implementations of the first aspect. Specifically, the first communication apparatus may include modules configured to perform the method according to any one of the first aspect or the possible implementations of the first aspect, for example, include a processing module and a transceiver module. For example, the transceiver module may include a sending module and a receiving module. The sending module and the receiving module may be different function modules, or may be a same function module that can implement different functions. For example, the first communication apparatus is a terminal device, or is a chip or another component disposed in the terminal device. For example, the communication device is the terminal device. An example in which the first communication apparatus is the terminal device is used below. For example, the transceiver module may alternatively be implemented by a transceiver, and the processing module may alternatively be implemented by a processor. Alternatively, the sending module may be implemented by a transmitter, and the receiving module may be implemented by a receiver. The transmitter and the receiver may be different function modules, or may be a same function module that can implement different functions. If the first communication apparatus is the terminal device, the transceiver is implemented by, for example, an antenna, a feeder, and a codec in the terminal device. Alternatively, if the first communication apparatus is the chip disposed in the terminal device, the transceiver (or the transmitter and the receiver) is, for example, a communication interface in the chip, and the communication interface is connected to a radio frequency transceiver component in the terminal device, to implement information receiving and sending by using the radio frequency transceiver component. In a description process of the third aspect, that the first communication apparatus is the terminal device including the processing module and the transceiver module is still used as an example for description.

The transceiver module is configured to receive first multicast configuration information from a network device, where the first multicast configuration information is for indicating to send first feedback information for a first multicast service, the first multicast configuration information corresponds to the first multicast service, the first multicast configuration information includes first indication information, and the first indication information is for indicating to send the first feedback information for the first multicast service.

The processing module is configured to determine, based on the first indication information, that the terminal device needs to provide a feedback for the first multicast service.

The transceiver module is further configured to: receive the first multicast service from the network device, and send the first feedback information to the network device.

In a possible design, the first multicast configuration information further includes a group radio network temporary identifier (group radio network temporary identifier, G-RNTI) and/or a multicast service identifier that are/is associated with the first multicast service, and the G-RNTI and/or the multicast service identifier are/is associated with the first indication information.

In a possible design, the first indication information indicates, by using a bit or a field, to provide a feedback for the first multicast service.

In a possible design, the first indication information is for indicating a transmission resource of the first feedback information.

In a possible design, the first indication information may include a signal quality parameter threshold, and the receiving module determines, based on the signal quality parameter threshold, whether the feedback information needs to be sent. Specifically, after the receiving module receives the first indication information, the processing module sends the first feedback information to the network device through the transceiver module only when determining that a value of a signal quality parameter corresponding to the first multicast service is less than or equal to the threshold. Otherwise, the first feedback information is not sent.

In a possible design, the transceiver module is further configured to receive second multicast configuration information from the network device, where the second multicast configuration information corresponds to a second multicast service, the second multicast configuration information includes second indication information, and the second indication information is for indicating that the terminal device does not need to send feedback information for the second multicast service. In this way, after receiving the second multicast service, the terminal device does not provide a feedback.

In a possible design, when a feedback resource of the first multicast service conflicts with a feedback resource of a unicast service, the processing module may determine, based on a priority of feedback information, whether to send the first feedback information of the first multicast service to the network device. Specifically, if it is agreed on in advance in a protocol that a priority of feedback information of a multicast service is higher than a priority of feedback information of a unicast service, the transceiver module may preferentially send the first feedback information corresponding to the first multicast service to the network device, and discard feedback information corresponding to the unicast service. If it is agreed on in advance in a protocol that a priority of feedback information of a multicast service is not higher than a priority of feedback information of a unicast service, the transceiver module preferentially sends feedback information corresponding to the unicast service to the network device, and discards the first feedback information corresponding to the first multicast service.

In a possible design, the transceiver module may further receive third indication information from the network device, where the indication information is for indicating a priority of the feedback information of the multicast service. The third indication information may be carried together with the multicast configuration information in downlink control information (downlink control information, DCI) or a radio resource control (radio resource control, RRC) message. In response to the third indication information, if the third indication information indicates that the priority of the feedback information of the first multicast service is a first priority (for example, a high-level priority), the processing module determines to preferentially send the first feedback information corresponding to the first multicast service to the network device through the transceiver module, and discard feedback information corresponding to the unicast service. If the third indication information indicates that the priority of the feedback information of the first multicast service is a second priority (for example, a low-level priority), the processing module determines to preferentially send feedback information corresponding to the unicast service to the network device through the transceiver module, and discard the first feedback information corresponding to the first multicast service.

In a possible design, the transceiver module is further configured to send fourth indication information to the terminal device, where the fourth indication information is for triggering the terminal device to send feedback stopping acknowledgment information to the network device. Because the terminal device receives the fourth indication information, the terminal device is triggered to send the feedback stopping acknowledgment information to the network device. The fourth indication information may be carried in DCI, an RRC message, or a media access control (media access control, MAC) control element (control element, CE). In this way, the terminal device can stop, in a timely manner based on an indication of the network device, providing a feedback for the first multicast service. The terminal device releases a PUCCH resource configured for multicast feedback, so that resource utilization is improved.

In a possible design, the feedback stopping acknowledgment information may be in a MAC sub-protocol data unit (protocol data unit, PDU). The MAC sub-PDU includes a MAC subheader and a MAC CE, and the MAC subheader includes a logical channel identifier (logical channel identifier, LCID). In a possible manner, the feedback stopping acknowledgment information may be indicated by the logical channel identifier LCID. For example, if the LCID takes a preset value (for example, the value is 33), it indicates that the terminal device stops sending the feedback information for the first multicast service. In another possible manner, the feedback stopping acknowledgment information may be indicated by a length of the MAC CE. For example, if the length of the MAC CE is a preset length, the MAC CE with the preset length is for indicating that sending of the feedback information for the first multicast service is stopped. In still another possible manner, the feedback stopping acknowledgment information may be indicated by the multicast service identifier or the G-RNTI in the MAC CE.

For technical effects brought by the third aspect or the optional implementations, refer to the descriptions of the technical effects brought by the first aspect or the corresponding implementations.

According to a fourth aspect, a second communication apparatus is provided. The second communication apparatus is configured to perform the method according to any one of the second aspect or the possible implementations of the second aspect. Specifically, the second communication apparatus may include modules configured to perform the method according to any one of the second aspect or the possible implementations of the second aspect, for example, include a processing module and a transceiver module. For example, the transceiver module may include a sending module and a receiving module. The sending module and the receiving module may be different function modules, or may be a same function module that can implement different functions. For example, the communication device is a network device. An example in which the second communication apparatus is the network device is used below. For example, the transceiver module may alternatively be implemented by a transceiver, and the processing module may alternatively be implemented by a processor. Alternatively, the sending module may be implemented by a transmitter, and the receiving module may be implemented by a receiver. The transmitter and the receiver may be different function modules, or may be a same function module that can implement different functions. If the second communication apparatus is the network device, the transceiver is implemented by, for example, an antenna, a feeder, and a codec in the network device. Alternatively, if the second communication apparatus is a chip disposed in the network device, the transceiver (or the transmitter and the receiver) is, for example, a communication interface in the chip, and the communication interface is connected to a radio frequency transceiver component in the network device, to implement information receiving and sending by using the radio frequency transceiver component. In a description process of the fourth aspect, that the second communication apparatus is the network device including the processing module and the transceiver module is still used as an example for description.

The processing module is configured to determine first multicast configuration information.

The transceiver module is configured to send the first multicast configuration information to a terminal device, where the first multicast configuration information corresponds to a first multicast service, the first multicast configuration information includes first indication information, and the first indication information is for indicating to send first feedback information for the first multicast service. Then, the transceiver module sends the first multicast service to the terminal device, and receives the first feedback information from the terminal device.

In a possible design, the first multicast configuration information further includes a group radio network temporary identifier G-RNTI and/or a multicast service identifier that are/is associated with the first multicast service, and the G-RNTI and/or the multicast service identifier are/is associated with the first indication information.

In a possible design, the first indication information indicates, by using a bit or a field, to provide a feedback for the first multicast service; and/or the first indication information is for indicating a transmission resource of the first feedback information.

In a possible design, the processing module is configured to determine, based on at least one of a service requirement of the first multicast service, a physical relative distance between the terminal device and the network device, and channel quality of the terminal device, the terminal device that needs to send the feedback information for the first multicast service.

In a possible design, the transceiver module is further configured to send second multicast configuration information to the terminal device, where the second multicast configuration information corresponds to a second multicast service, the second multicast configuration information includes second indication information, and the second indication information is for indicating that the terminal device does not need to send feedback information for the second multicast service.

In a possible design, before receiving the first feedback information from the terminal device, the transceiver module is further configured to send third indication information to the terminal device, where the third indication information is for indicating a priority of the feedback information of the first multicast service. The third indication information is carried in downlink control information DCI, and the DCI is for scheduling a physical downlink shared channel PDSCH that carries the first multicast service.

In a possible design, the transceiver module is further configured to: send fourth indication information to the terminal device, where the fourth indication information is for indicating the terminal device to stop sending the feedback information for the first multicast service; and receive feedback stopping acknowledgment information from the terminal device, where the feedback stopping acknowledgment information is for indicating that the terminal device stops sending the feedback information for the first multicast service.

In a possible design, the feedback stopping acknowledgment information is indicated by a logical channel identifier LCID, and the LCID is carried in a media access control MAC subheader; or the feedback stopping acknowledgment information is indicated by fifth indication information in a MAC control element CE; or the feedback stopping acknowledgment information is indicated by a length of a MAC CE.

In a possible design, the transceiver module is further configured to receive feedback capability information from the terminal device, where the feedback capability information is for indicating a capability of sending unicast feedback information and multicast feedback information on a same feedback resource by the terminal device, the unicast feedback information is feedback information corresponding to a unicast service, and the multicast feedback information is feedback information corresponding to a multicast service.

According to a fifth aspect, this application provides a communication apparatus. The communication apparatus may be a terminal device or a chip inside the terminal device. The communication apparatus has a function of implementing the first aspect. For example, the communication apparatus includes a processor, and the communication apparatus may further include a transceiver. The transceiver is configured to receive and send signals, and the processor executes program instructions to complete the method according to any possible design or implementation of the first aspect. The communication apparatus may further include one or more memories. The memory is configured to be coupled to the processor. The one or more memories may be integrated with the processor, or may be disposed independent of the processor. This is not limited in this application. The memory may store a necessary computer program or necessary instructions for implementing the functions in the first aspect. The processor may execute the computer program or the instructions stored in the memory. When the computer program or the instructions are executed, the communication apparatus is enabled to implement the method according to any possible design or implementation of the first aspect.

In a possible design, the communication apparatus includes a processor and a memory. The memory may store a necessary computer program or necessary instructions for implementing the functions in the first aspect. The processor may execute the computer program or the instructions stored in the memory. When the computer program or the instructions are executed, the communication apparatus is enabled to implement the method according to any possible design or implementation of the first aspect.

In a possible design, the communication apparatus includes at least one processor and an interface circuit. The at least one processor is configured to: communicate with another apparatus via the interface circuit, and perform the method performed by the terminal device in any possible design or implementation of the first aspect.

According to a sixth aspect, this application provides a communication apparatus. The communication apparatus may be a network device or a chip inside the network device. The communication apparatus has a function of implementing the second aspect. For example, the communication apparatus includes a processor, and the communication apparatus may further include a transceiver. The transceiver is configured to receive and send signals, and the processor executes program instructions to complete the method according to any possible design or implementation of the second aspect. The communication apparatus may further include one or more memories. The memory is configured to be coupled to the processor. The one or more memories may be integrated with the processor, or may be disposed independent of the processor. This is not limited in this application. The memory may store a necessary computer program or necessary instructions for implementing the functions in the second aspect. The processor may execute the computer program or the instructions stored in the memory. When the computer program or the instructions are executed, the communication apparatus is enabled to implement the method according to any possible design or implementation of the second aspect.

In a possible design, the communication apparatus includes a processor and a memory. The memory may store a necessary computer program or necessary instructions for implementing the functions in the second aspect. The processor may execute the computer program or the instructions stored in the memory. When the computer program or the instructions are executed, the communication apparatus is enabled to implement the method according to any possible design or implementation of the second aspect.

In a possible design, the communication apparatus includes at least one processor and an interface circuit. The at least one processor is configured to: communicate with another apparatus via the interface circuit, and perform the method according to any possible design or implementation of the second aspect.

According to a seventh aspect, this application provides a computer-readable storage medium. The computer storage medium stores computer-readable instructions; and when a computer reads and executes the computer-readable instructions, the computer is enabled to perform the method according to any possible design of the first aspect or the second aspect.

According to an eighth aspect, this application provides a computer program product. When a computer reads and executes the computer program product, the computer is enabled to perform the method according to any possible design of the first aspect or the second aspect.

According to a ninth aspect, this application provides a chip. The chip includes a processor. The processor is coupled to a memory, and is configured to read and execute a software program stored in the memory, to implement the method according to any possible design of the first aspect or the second aspect.

According to a tenth aspect, this application provides a communication system. The communication system includes a terminal device and a network device. The terminal device is configured to implement the method according to any possible design of the first aspect, and the network device is configured to implement the method according to any possible design of the first aspect.

These aspects or other aspects of this application are clearer and more comprehensible in descriptions of the following embodiments.

### BRIEF DESCRIPTION OF DRAWINGS

FIG. 1 is a schematic diagram of a network architecture to which an embodiment of this application is applicable;

FIG. 2 is a schematic diagram of another network architecture to which an embodiment of this application is applicable;

FIG. 3 is a schematic diagram of another network architecture to which an embodiment of this application is applicable;

FIG. 4A is a schematic diagram of performing multicast service transmission by a network device;

FIG. 4B is a schematic diagram of obtaining multicast configuration information by a terminal device;

FIG. 5 is a schematic interaction diagram of a communication method according to an embodiment of this application;

FIG. 6A and FIG. 6B are schematic diagrams of structures of MAC CEs according to an embodiment of this application;

FIG. 7A to FIG. 10 are schematic interaction diagrams of other communication methods according to embodiments of this application;

FIG. 11A to FIG. 11D are schematic diagrams of frame structures according to an embodiment of this application;

FIG. 12A to FIG. 12G are schematic diagrams of other frame structures and mapping patterns according to an embodiment of this application;

FIG. 13 is a possible example block diagram of an apparatus according to an embodiment of this application;

FIG. 14 is a schematic diagram of a structure of a terminal device according to an embodiment of this application; and

FIG. 15 is a schematic diagram of a structure of a network device according to an embodiment of this application.

### DETAILED DESCRIPTION OF EMBODIMENTS

The following describes technical solutions in embodiments of the present invention with reference to the accompanying drawings in embodiments of the present invention. It is clear that the described embodiments are merely some embodiments rather than all embodiments of the present invention.

Some terms in embodiments of this application are first described, to help a person skilled in the art have a better understanding.

(1) Terminal device: The terminal device may be a wireless terminal device that can receive scheduling information and indication information of a network device. The wireless terminal device may be a device that provides voice and/or data connectivity for a user, a handheld device with a wireless connection function, or another processing device connected to a wireless modem. The terminal device may communicate with one or more core networks or the Internet through a radio access network (radio access network, RAN). The terminal device may be a mobile terminal device, for example, a mobile phone (or referred to as a “cellular” phone or a mobile phone (mobile phone)), a computer, and a data card. For example, the terminal device may be a portable, pocket-sized, handheld, computer built-in, or in-vehicle mobile apparatus that exchanges voice and/or data with the radio access network. For example, the terminal device may be a personal communication service (personal communication service, PCS) phone, a cordless phone, a session initiation protocol (SIP) phone, a wireless local loop (wireless local loop, WLL) station, a personal digital assistant (personal digital assistant, PDA), a tablet computer (Pad), or a computer having wireless receiving and sending functions. The wireless terminal device may alternatively be referred to as a system, a subscriber unit (subscriber unit), a subscriber station (subscriber station), a mobile station (mobile station), a mobile station (mobile station, MS), a remote station (remote station), an access point (access point, AP), a remote terminal (remote terminal), an access terminal (access terminal), a user terminal (user terminal), a user agent (user agent), a subscriber station (subscriber station, SS), customer premises equipment (customer premises equipment, CPE), a terminal (terminal), user equipment (user equipment, UE), a mobile terminal (mobile terminal, MT), or the like. Alternatively, the terminal device may be a wearable device, a terminal device in a next-generation communication system, for example, a 5G communication system, a terminal device in a future evolved public land mobile network (public land mobile network, PLMN), or the like.

(2) Network device: The network device may be a device in a wireless network. For example, the network device may be a radio access network (radio access network, RAN) node (or device) that enables a terminal device to access the wireless network, and may also be referred to as a base station. Currently, some examples of the RAN device are: a next generation NodeB (generation NodeB, gNodeB) in a 5G communication system, a transmission reception point (transmission reception point, TRP), an evolved NodeB (evolved NodeB, eNB), a radio network controller (radio network controller, RNC), a NodeB (NodeB, NB), a base station controller (base station controller, BSC), a base transceiver station (base transceiver station, BTS), a home base station (for example, a home evolved NodeB or a home NodeB, HNB), a baseband unit (baseband unit, BBU), a wireless fidelity (wireless fidelity, Wi-Fi) access point (access point, AP), and the like. In addition, in a network structure, the network device may include a centralized unit (centralized unit, CU) node, a distributed unit (distributed unit, DU) node, or a RAN device including a CU node and a DU node. In addition, in another possible case, the network device may be another apparatus that provides a wireless communication function for the terminal device. A specific technology and a specific device form that are used by the network device are not limited in embodiments of this application. For ease of description, in embodiments of this application, an apparatus that provides a wireless communication function for a terminal device is referred to as a network device.

(3) Radio resource control (radio resource control, RRC) status: A terminal device has three RRC statuses: an RRC connected state (connected state), an RRC idle state (idle state), and an inactive state (inactive state).

RRC connected state (or may be referred to as a connected state for short, where in this specification, the “connected state” and the “RRC connected state” are a same concept, and the two names may be interchanged): The terminal device establishes an RRC connection to a network, and may perform data transmission.

RRC idle state (or may be referred to as an idle state for short, where in this specification, the “idle state” and the “RRC idle state” are a same concept, and the two names may be interchanged): The terminal device does not establish the RRC connection to the network, and a base station does not store a context of the terminal device. If the terminal device needs to enter the RRC connected state from the RRC idle state, the terminal device needs to initiate an RRC connection establishment process.

RRC inactive state (or may be referred to as an inactive state for short, where in this specification, an “inactivated state”, a “deactivated state”, the “inactive state”, the “RRC inactive state”, and an “RRC deactivated state” are a same concept, and these names may be interchanged): The terminal device previously enters the RRC connected state, and then the base station releases the RRC connection, but the base station stores the context of the terminal device. If the terminal device needs to enter the RRC connected state again from the RRC inactive state, the terminal device needs to initiate an RRC connection resume process (or referred to as an RRC connection reestablishment process). Compared with the RRC connection establishment process, the RRC connection resume process has a shorter latency and smaller signaling overheads. However, the base station needs to store the context of the terminal device, causing storage overheads of the base station.

(4) Terms “system” and “network” in embodiments of this application may be used interchangeably. “At least one” means one or more, and “a plurality of” means two or more. The term “and/or” describes an association relationship between associated objects and indicates that three relationships may exist. For example, A and/or B may indicate the following cases: Only A exists, both A and B exist, and only B exists, where Δ and B may be singular or plural. The character “/” generally indicates an “or” relationship between the associated objects. “At least one of the following items (pieces)” or a similar expression thereof means any combination of these items, including any combination of singular items (pieces) or plural items (pieces). For example, “at least one of A, B, and C” includes A, B, C, AB, AC, BC, or ABC.

In addition, unless otherwise stated, ordinal numbers such as “first” and “second” in embodiments of this application are used to distinguish between a plurality of objects, and are not used to limit an order, a time sequence, priorities, or importance of the plurality of objects. For example, a first threshold and a second threshold are merely used to distinguish between different thresholds, and do not indicate different priorities, different importance, or the like of the two thresholds.

The following further describes the technical solutions of this application in detail with reference to the accompanying drawings of this specification.

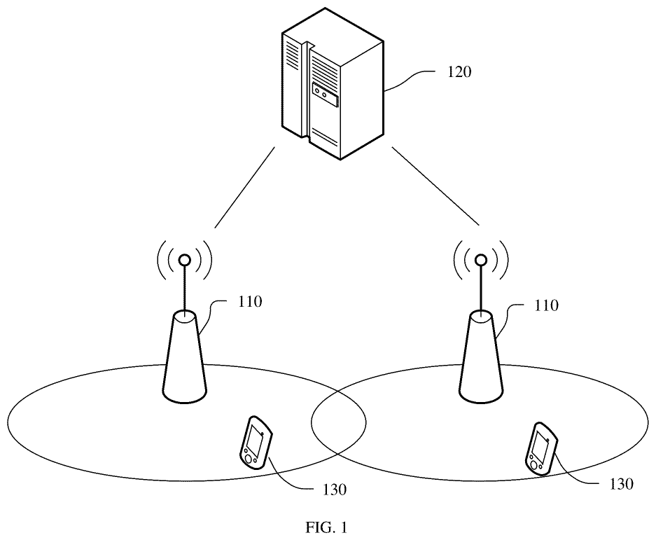

FIG. 1 is a schematic diagram of a network architecture to which an embodiment of this application is applicable. As shown in FIG. 1, a terminal device 130 may access a wireless network, to obtain a service of an external network (for example, the Internet) through the wireless network, or communicate with another device through the wireless network, for example, may communicate with another terminal device. The wireless network includes a radio access network (radio access network, RAN) device 110 and a core network (core network, CN) device 120. The RAN device 110 is configured to enable the terminal device 130 to access the wireless network, and the CN device 120 is configured to manage the terminal device and provide a gateway for communicating with the external network. It should be understood that a quantity of devices in the communication system shown in FIG. 1 is merely used as an example. Embodiments of this application are not limited thereto. During actual application, the communication system may further include more terminal devices 130 and more RAN devices 110, and may further include another device.

A CN may include a plurality of CN devices 120. When the network architecture shown in FIG. 1 is applicable to a 5G communication system, the CN device 120 may be an access and mobility management function (access and mobility management function, AMF) entity, a session management function (session management function, SMF) entity, a user plane function (user plane function, UPF) entity, or the like. When the network architecture shown in FIG. 1 is applicable to an LTE communication system, the CN device 120 may be a mobility management entity (mobility management entity, MME), a serving gateway (serving gateway, S-GW), or the like.

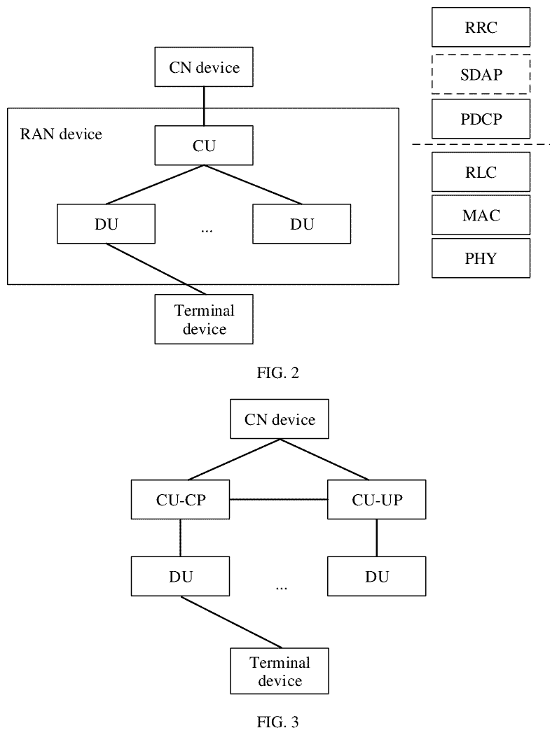

FIG. 2 is a schematic diagram of another network architecture to which an embodiment of this application is applicable. As shown in FIG. 2, the network architecture includes a CN device, a RAN device, and a terminal device. The RAN device includes a baseband apparatus and a radio frequency apparatus. The baseband apparatus may be implemented by one node, or may be implemented by a plurality of nodes. The radio frequency apparatus may be independently implemented remotely from the baseband apparatus or may be integrated into the baseband apparatus, or some functions are independently integrated and some functions are integrated into the baseband apparatus. For example, in an LTE communication system, a RAN device (eNB) includes a baseband apparatus and a radio frequency apparatus. The radio frequency apparatus may be remotely disposed relative to the baseband apparatus. For example, a remote radio unit (remote radio unit, RRU) is a remote radio unit disposed relative to a BBU.

Communication between the RAN device and the terminal device complies with a specific protocol layer structure. For example, a control plane protocol layer structure may include functions of protocol layers such as a radio resource control (radio resource control, RRC) layer, a packet data convergence protocol (packet data convergence protocol, PDCP) layer, a radio link control (radio link control, RLC) layer, a media access control (media access control, MAC) layer, and a physical layer. A user plane protocol layer structure may include functions of protocol layers such as the PDCP layer, the RLC layer, the MAC layer, and the physical layer. In a possible implementation, a service data adaptation protocol (service data adaptation protocol, SDAP) layer may be further included above the PDCP layer.

The RAN device may implement functions of protocol layers such as the RRC layer, the PDCP layer, the RLC layer, and the MAC layer through one node or a plurality of nodes. For example, in an evolved structure, the RAN device may include a centralized unit (CU) and a distributed unit (DU), and a plurality of DUs may be centrally controlled by one CU. As shown in FIG. 2, the CU and the DU may be obtained through division based on a protocol layer of a wireless network. For example, functions of the PDCP layer and a protocol layer above the PDCP layer are set on the CU, and functions of protocol layers below the PDCP layer, such as the RLC layer and the MAC layer, are set on the DU.

Division based on the protocol layer is merely an example, and division may alternatively be performed based on another protocol layer, for example, the RLC layer. Functions of the RLC layer and a layer above the RLC layer are set on the CU, and a function of a protocol layer below the RLC layer is set on the DU. Alternatively, division is performed at a protocol layer. For example, some functions of the RLC layer and a function of a protocol layer above the RLC layer are set on the CU, and a remaining function of the RLC layer and a function of a protocol layer below the RLC layer are set on the DU. In addition, division may alternatively be performed in another manner. For example, division is performed based on a latency. A function whose processing time needs to satisfy a latency requirement is set on the DU, and a function whose processing time does not need to satisfy the latency requirement is set on the CU.

In addition, the radio frequency apparatus may be independently integrated but not disposed in the DU, or may be integrated into the DU, or some remote parts are integrated into the DU. This is not limited herein.

FIG. 3 is a schematic diagram of another network architecture to which an embodiment of this application is applicable. Based on the network architecture shown in FIG. 2, in FIG. 3, a control plane (CP) and a user plane (UP) of the CU may be further separated and implemented as different entities, which are separately a control plane (control plane, CP) CU entity (namely, a CU-CP entity) and a user plane (user plane, UP) CU entity (namely, a CU-UP entity).

In the foregoing network architecture, signaling generated by the CU may be sent to the terminal device through the DU, or signaling generated by the terminal device may be sent to the CU through the DU. The DU may transparently transmit the signaling to the terminal device or the CU by directly encapsulating the signaling at a protocol layer without parsing the signaling. In the following embodiments, if transmission of such signaling between the DU and the terminal device is involved, sending or receiving of the signaling by the DU includes this scenario. For example, signaling at the RRC layer or the PDCP layer is finally processed as signaling at the PHY layer and sent to the terminal device, or is converted from received signaling at the PHY layer. In this architecture, it may also be considered that the signaling at the RRC layer or the PDCP layer is sent by the DU, or sent by the DU and the radio frequency apparatus.

The network architecture shown in FIG. 1, FIG. 2, or FIG. 3 is applicable to communication systems of various radio access technologies (radio access technologies, RATs). For example, the communication system may be an LTE communication system, or may be a 5G (or referred to as new radio (new radio, NR)) communication system, or may be a transition system between an LTE communication system and a 5G communication system, or certainly may be a future communication system. The transition system may also be referred to as a 4.5G communication system. Network architectures and service scenarios described in embodiments of this application are intended to describe the technical solutions in embodiments of this application more clearly, and do not constitute any limitation on the technical solutions provided in embodiments of this application. A person of ordinary skill in the art may know that, with evolution of the communication network architecture and emergence of new service scenarios, the technical solutions provided in embodiments of this application are also applicable to similar technical problems.

An apparatus in the following embodiments of this application may be located in a terminal device or a network device based on a function implemented by the apparatus. When the foregoing CU-DU structure is used, the network device may be a CU node, a DU node, or a RAN device including a CU node and a DU node.

In the network architecture shown in FIG. 1, FIG. 2, or FIG. 3, the network device may transmit service data to a terminal device in a multicast mode, for example, implement multicast transmission by using an SC-PTM technology. In an SC-PTM broadcast mode, an access network device configures a single-cell multicast control channel (single-cell multicast control channel, SC-MCCH) by using a SIB, including a time domain position of the SC-MCCH. SC-PTM configuration information carried on the SC-MCCH includes configuration information of a single-cell multicast traffic channel (single-cell multicast traffic channel, SC-MTCH). The configuration information includes a temporary mobile group identity (temporary mobile group identity, TMGI), a session identifier (session ID), a G-RNTI for scrambling DCI, and configuration information of time domain discontinuous reception (discontinuous reception, DRX). It should be noted that the two logical channels SC-MCCH and SC-MTCH are both mapped to a physical downlink shared channel (physical downlink shared channel, PDSCH) at a physical layer, and the DCI is carried on a physical downlink control channel (physical downlink control channel, PDCCH). In the SC-PTM technology, a physical downlink shared channel (physical downlink shared channel, PDSCH) may be used to transmit a multicast service. The network device may send, to a group of terminal devices in a cell, downlink control information (downlink control information, DCI) carried on a physical downlink control channel (physical downlink control channel, PDCCH). The DCI is for scheduling a multicast PDSCH that carries a multicast service, and the DCI may be scrambled by using a group radio network temporary identifier (group radio network temporary identifier, G-RNTI) associated with the multicast service. The terminal device obtains, by detecting the DCI scrambled by using the group radio network temporary identifier (Group radio network temporary identifier, G-RNTI), the physical downlink channel PDSCH scheduled by the DCI, and further obtains service data carried on the PDSCH.

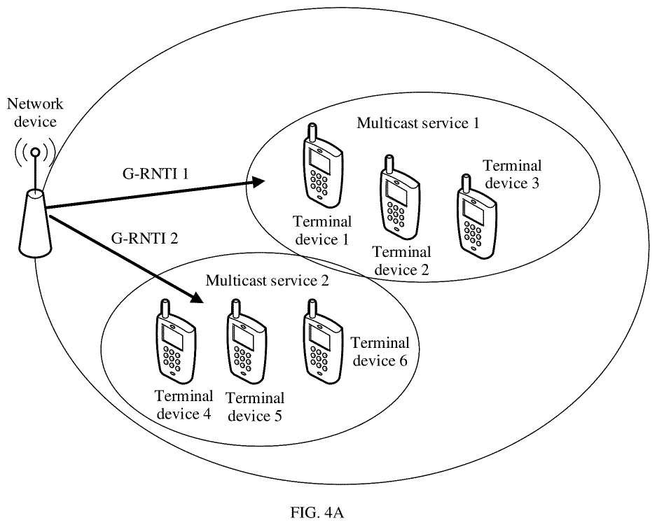

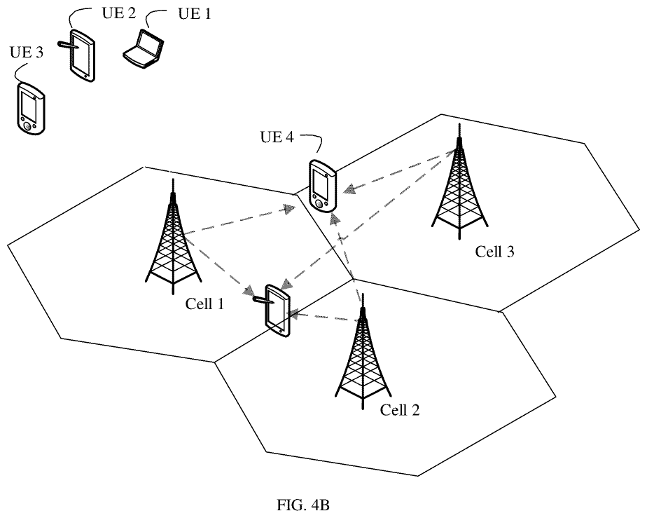

FIG. 4A shows a case in which a network device transmits three multicast services. The network device may allocate a G-RNTI 1 for a first multicast service, allocate a G-RNTI 2 for a second multicast service, and allocate a G-RNTI 3 for a third multicast service. To be specific, a G-RNTI associated with the first multicast service is the G-RNTI 1, a G-RNTI associated with the second multicast service is the G-RNTI 2, and a G-RNTI associated with the third multicast service is the G-RNTI 3. To receive the first multicast service and the second multicast service, a first group of terminal devices (including, for example, a terminal device 1, a terminal device 2, and a terminal device 3) need to obtain first multicast configuration information of the first multi cast service, where the first multicast configuration information is for indicating the first group of terminal devices to receive the first multicast service (where for example, the first multicast configuration information may include the G-RNTI 1 associated with the first multicast service). Then, the first group of terminal devices receive, based on the G-RNTI 1, DCI 1 that is from the network device and that is for scheduling a multicast PDSCH 1 (where the multicast PDSCH 1 is for carrying the first multicast service), and receive the multicast PDSCH 1. Similarly, to receive the second multicast service, the first group of terminal devices (including, for example, the terminal device 1, the terminal device 2, and the terminal device 3) need to obtain second multicast configuration information of the second multicast service (where for example, the second multicast configuration information may include the G-RNTI 2 associated with the second multicast service), where the second multicast configuration information is for indicating the first group of terminal devices to receive the second multicast service. Then, the first group of terminal devices receive, based on the G-RNTI 2, DCI 2 that is from the network device and that is for scheduling a multicast PDSCH 2 (where the multicast PDSCH 2 is for carrying the second multicast service), and receive the multicast PDSCH 2.

Similarly, to receive the second multicast service, a second group of terminal devices (including, for example, a terminal device 4, a terminal device 5, and a terminal device 6) need to obtain the second multicast configuration information of the second multicast service (where for example, the second multicast configuration information may include the G-RNTI 2 associated with the second multicast service), where the second multicast configuration information is for indicating the second group of terminal devices to receive the multicast service 2. Then, the second group of terminal devices receive, based on the G-RNTI 2, the DCI 2 that is from the network device and that is for scheduling the multicast PDSCH 2 (where the multicast PDSCH 2 is for carrying the second multicast service), and receive the multicast PDSCH 2.

For example, FIG. 4B is a schematic diagram of deployment of a mobile communication network, where the network includes one or more base stations. Each base station manages one or more cells (cell). In FIG. 4B, an example in which one base station manages one cell is used. Several UEs are distributed in each cell. These UEs may be connected to a base station through air interfaces (air interface), and can receive a communication service after accessing the cell. Sports live broadcast is used as an example. Assuming that a plurality of user equipments simultaneously request a sports live broadcast service, the base station may simultaneously transmit same video content to the plurality of terminal devices (for example, UE 1, UE 2, and UE 3 in FIG. 4B) by using a point-to-multipoint multicast bearer PDSCH 1.

It can be learned that a multicast transmission technology can effectively ensure service experience of a user, and a larger quantity of terminal devices brings higher network resource utilization. However, currently, the multicast transmission technology does not support hybrid automatic repeat request (hybrid automatic repeat request, HARQ) feedback. Consequently, after receiving a multicast service, a terminal device does not feed back whether the multicast service is correctly received. For some multicast services that have high reliability requirements, the current multicast transmission technology cannot meet the reliability requirements of these multicast services. Based on this, in embodiments of this application, the current multicast transmission technology is improved to support a feedback mechanism. In this way, the terminal device may provide, based on indication information of a network device, a feedback for a multicast service for which a feedback needs to be provided, so that reliability of the multicast service is improved.

The following describes in detail, with reference to the accompanying drawings, a process in which a terminal device provides a feedback for a multicast service.

### Embodiment 1

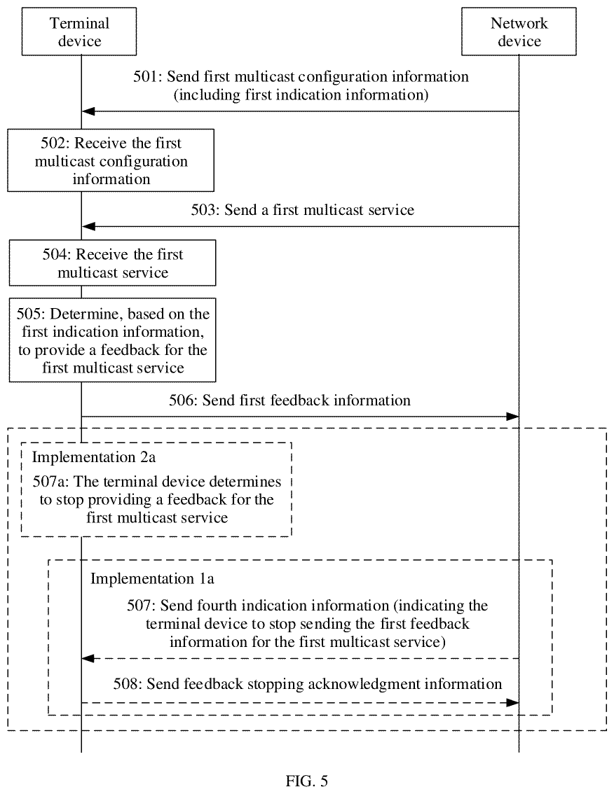

FIG. 5 is a schematic flowchart of a communication method according to this embodiment of this application. The method may include the following steps.

Step 501: A network device sends first multicast configuration information to a terminal device, where the first multicast configuration information corresponds to a first multicast service, the first multicast configuration information includes first indication information, and the first indication information is for indicating to send first feedback information for the first multicast service.

It should be noted that the first multicast configuration information is for indicating the terminal device to receive the first multicast service. Optionally, the first multicast configuration information may be carried in an RRC message, system information, or a common channel. The first multicast configuration information is multicast configuration information corresponding to the first multicast service, and is for indicating the terminal device to receive the first multicast service based on the first multicast configuration information. The first multicast configuration information includes the first indication information. Generally, multicast configuration information may further include at least one of the following parameters: (1) a G-RNTI, (2) a multicast service identifier, (3) BWP information corresponding to the G-RNTI, (4) a PDSCH scrambling sequence of a multicast service, (5) a DRX parameter of the G-RNTI, (6) a demodulation reference signal, (7) a rate matching reference signal, (8) a radio bearer identifier, and (9) a security configuration identifier.

(1) The G-RNTI is in one-to-one correspondence with the multicast service. In this embodiment of this application, the first multicast configuration information may further include a G-RNTI 1 that is in one-to-one correspondence with the first multicast service. In other words, the G-RNTI 1 is equivalent to an identifier of the first multicast service. In this embodiment of this application, the first indication information may be associated with the G-RNTI 1, that is, the first indication information corresponds to the first multicast service.

(2) The multicast service identifier includes an internet protocol (internet protocol, IP) address and/or a port number of the multicast service.

The multicast service identifier may be sent by an application server to a core network device, and then the core network device sends the multicast service identifier to a network device. The multicast service identifier may alternatively be a temporary mobile group identity (temporary mobile group identity, TMGI). In this embodiment of this application, the first multicast configuration information may further include an IP address and/or a port number of the first multicast service, and the first indication information may be associated with the IP address and/or the port number of the first multicast service. Specifically, the first indication information may indicate the terminal device to send the first feedback information for a multicast service corresponding to a first IP address and/or a first port number.

(3) The BWP information corresponding to the G-RNTI includes at least one of the following: a bandwidth, a frequency position, a subcarrier spacing (subcarrier spacing, SCS), a cyclic prefix (cyclic prefix, CP) length, configuration information related to a control resource set (control resource set, CORESET), and configuration information related to a PDSCH. The CORESET information is for indicating a time-frequency resource on which a PDCCH scrambled by using the G-RNTI is located. In this embodiment of this application, the first multicast configuration information may further include BWP information corresponding to the G-RNTI 1.

(4) PDSCH scrambling sequence of the multicast service: A terminal device descrambles the PDSCH of the multicast service by using the PDSCH scrambling sequence.

(5) DRX parameter of the G-RNTI: The terminal device performs G-RNTI detection by using the DRX parameter.

(6) Demodulation reference signal: The terminal device demodulates, by using the demodulation reference signal, the PDSCH scheduled by using the G-RNTI.

(7) Rate matching reference signal: When receiving the PDSCH scheduled by using the G-RNTI, the terminal device excludes a position corresponding to the rate matching reference signal.

(8) The radio bearer identifier is for identifying a radio bearer corresponding to the first multicast service. The radio bearer may be a data radio bearer, for example, a DRB (Data Radio Bearer), or a multicast radio bearer introduced for the multicast service, for example, an MRB (Multicast Radio Bearer).

(9) The security configuration identifier is for identifying a security configuration corresponding to the first multicast service, and the security configuration may include at least one of an encryption algorithm indication and an integrity protection algorithm indication.

In a possible embodiment, in step 501, the network device may indicate, in the first indication information by using an explicit indication method or an implicit indication method, whether the terminal device needs to send the feedback information.

Specifically, the network device may send, to the terminal device in any one or more of the following manners, the first indication information that is for indicating whether to provide a feedback for the first multicast service.

### Manner 1

The first indication information explicitly indicates whether the terminal device needs to provide a feedback for the received first multicast service. For example, the network device may indicate, in the first indication information by using one bit or one special field, the network device 1 to provide a feedback for the first multicast service.

It should be noted that the network device may alternatively indicate, in the first indication information by using two or more bits, to provide a feedback for the first multicast service. Alternatively, the network device may indicate, in the first indication information by using two or more fields, to provide a feedback for the first multicast service. This is not specifically limited in this embodiment of this application.

### Manner 2

The first indication information implicitly indicates whether the terminal device needs to provide a feedback for the received first multicast service. For example, the network device 1 may indicate, in the first indication information, a transmission resource of the first feedback information corresponding to the first multicast service. The transmission resource is for carrying the first feedback information of the terminal device for the first multicast service.

For example, if the network device configures, for the terminal device, a PUCCH resource used for hybrid automatic repeat request (hybrid automatic repeat request, HARQ) feedback for the first multicast service, it is equivalent to indicating that the terminal device needs to provide a feedback. The PUCCH resource may be different from a PUCCH resource used for HARQ feedback on a unicast service.

### Manner 3

The first indication information includes an auxiliary parameter, and the terminal device determines, based on the auxiliary parameter, whether to provide a feedback for the first multicast service. For example, the network device may transmit a signal quality parameter threshold by using the first indication information. A signal quality parameter may be at least one of the following: reference signal received power (reference signal received power, RSRP), reference signal received quality (reference signal received quality, RSRQ), a received signal strength indication (received signal strength indication, RSSI), channel quality information (channel quality information, CQI), and the like. After receiving the first indication information, the terminal device further determines, based on the threshold and a measured value of the signal quality parameter, whether to provide a feedback. For details, refer to the following step 504.

### Manner 4

The network device may indicate, in the first indication information with reference to at least two of the manner 1 to the manner 3, whether the terminal device needs to provide a feedback for the first multicast service.

For example, the network device may indicate, with reference to the manner 1 and the manner 3, whether the terminal device needs to provide a feedback. For example, the network device indicates, in the first indication information by using one bit or one field, that the terminal device needs to provide a feedback for the first multicast service, and the network device further indicates, in the first indication information, a transmission resource of the first feedback information corresponding to the first multicast service. Correspondingly, the terminal device determines, based on the bit or the field in the first indication information, that the terminal device needs to provide a feedback for the first multicast service, and may send the first feedback information to the network device on the transmission resource indicated in the first indication information.

In a possible embodiment, before performing step 501, the network device needs to determine the terminal device that needs to provide a feedback for the multicast service. A determining method used by the network device may include one or more of the following manners.

### Manner 1

The network device may determine, based on a service requirement of the multicast service corresponding to a group of terminal devices to which the terminal device belongs, the terminal device that needs to provide a feedback for the multicast service. For example, the network device determines whether the multicast service sent by the network device to the terminal device is a multicast service that the terminal device is interested in. If yes, the network device determines that the terminal device needs to provide a feedback for the multicast service. A group of terminal devices is a set of terminal devices that receive a same multicast service. For example, in FIG. 4A, the terminal device 1, the terminal device 2, and the terminal device 3 form the first group of terminal devices that receive a multicast service 1.

For example, in the foregoing embodiment, the group of terminal devices to which the terminal device belongs is the first group of terminal devices in FIG. 4A. It is assumed that a service requirement of the first multicast service corresponding to the first group of terminal devices is a high reliability requirement.

In a possible manner, the network device determines that a part of terminal devices that are in the first group of terminal devices and that receive the first multicast service need to provide feedbacks for the first multicast service. The network device may configure the part of terminal devices in the first group of terminal devices to provide feedbacks for the first multicast service, and configure the remaining part of terminal devices not to provide feedbacks for the first multicast service. In principle, because the service requirement of the first multicast service is the high reliability requirement, the network device needs to configure all terminal devices that receive the first multicast service to provide feedbacks. However, in consideration of at least one of feedback resources that can be provided by a network, channel quality between the terminal devices and the network device, and receiving capabilities of the terminal devices, the network device selects a part of terminal devices and configures feedback resources for the part of terminal devices, so that receiving of the first multicast service can be ensured, configurations of feedback resources can be reduced, and resource utilization can be improved.

In another possible manner, the network device may determine that all terminal devices that are in the first group of terminal devices and that receive the first multicast service need to provide feedbacks for the first multicast service. The network device may configure all the terminal devices in the first group of terminal devices to provide feedbacks for the first multicast service.

### Manner 2

The network device may determine, based on a physical distance and/or a transmission distance between a terminal device and the network device, whether the terminal device needs to provide a feedback for the multicast service.

For example, if the physical distance between the terminal device and the network device exceeds a specified threshold, the network device may indicate that the terminal device needs to provide a feedback for the received multicast service. On the contrary, if the physical distance between the terminal device and the network device does not exceed the specified threshold, the network device may indicate that the terminal device does not need to provide a feedback for the received multicast service.

### Manner 3

The network device may determine, based on a channel quality status of a terminal device, whether the terminal device needs to provide a feedback for the multicast service.

For example, the network device may determine the channel quality status of the terminal device based on a transmission channel (for example, a PDSCH) corresponding to the first multicast service. If channel quality of the terminal device is poor, the network device may indicate that the terminal device needs to provide a feedback for the received multicast service. On the contrary, if the channel quality of the terminal device is good, the network device may indicate that the terminal device does not need to provide a feedback for the received multicast service.

Step 502: The terminal device receives the first multicast configuration information.

In an example, the terminal device may receive the first multicast configuration information from the network device through a radio resource control (radio resource control, RRC) connection.

In another example, the terminal device may receive the first multicast configuration information from the network device by using the common channel or the system information.

In still another example, the terminal device may receive the first multicast configuration information from the network device in a random access procedure.

Step 503: The network device sends the first multicast service to the terminal device.

Step 504: The terminal device receives the first multicast service based on the first multicast configuration information.

In a possible implementation, when the first multicast configuration information further includes the G-RNTI 1 associated with the first multicast service in addition to the first indication information, the terminal device may descramble, based on the G-RNTI 1, DCI 1 that is from the network device, and further receive the first multicast service carried on a multicast PDSCH 1, where the DCI 1 is for scheduling the multicast PDSCH 1.

Step 505: After receiving the first multicast service, the terminal device determines, based on the first indication information, whether to provide a feedback for the first multicast service. If yes, the terminal device performs a subsequent step. Otherwise, the terminal device stops performing the subsequent step.

In a possible embodiment, in step 505, the terminal device may determine, based on the first indication information in any one or more of the following manners, whether to provide a feedback for the first multicast service.

### Manner 1

The terminal device determines, based on a value of the bit that is in the first indication information and that corresponds to the first multicast service, whether to provide a feedback for the received first multicast service, or determines, based on the special field in the first indication information, whether to provide a feedback for the received first multicast service.

Specifically, after the terminal device receives the first indication information, and when the value of the bit that is in the first indication information and that corresponds to the terminal device is a first specified value (for example, “1”), the terminal device determines that the terminal device needs to provide a feedback for the first multicast service. After the terminal device receives the first indication information, and when the value of the bit that is in the first indication information and that corresponds to the terminal device is a second specified value (for example, “0”), the terminal device determines that the terminal device does not need to provide a feedback for the first multicast service.

Alternatively, after the terminal device receives the first indication information, if the first indication information includes a field that is agreed on in a protocol, the terminal device determines that the terminal device needs to provide a feedback for the first multicast service. After the terminal device receives the first indication information, if the first indication information does not include the field that is agreed on in the protocol, the terminal device determines that the terminal device does not need to provide a feedback for the first multicast service.

### Manner 2

If determining that the first indication information indicates a transmission resource of the first multicast service, the terminal device provides a feedback for the received first multicast service. If determining that the first indication information does not indicate the transmission resource of the first multicast service, the terminal device does not provide a feedback for the received first multicast service.

### Manner 3

After the terminal device receives the first indication information, if the first indication information includes the signal quality parameter threshold, and the terminal device determines that the value of the signal quality parameter of the first multicast service is less than or equal to the threshold, the terminal device determines to provide a feedback for the first multicast service.

For example, the terminal device may determine, based on at least one of the following conditions, that the terminal device needs to provide a feedback for the first multicast service. Condition 1: An RSRP value of the first multicast service that is measured by the terminal device is less than or equal to an RSRP threshold. Condition 2: An RSRQ value of the first multicast service that is measured by the terminal device is less than or equal to an RSRQ threshold. Condition 3: An SINR value of the first multicast service that is measured by the terminal device is less than or equal to an SINR threshold. Condition 4: A CQI value of the first multicast service that is measured by the terminal device is less than or equal to a CQI threshold. Condition 5: An RSSI value of the first multicast service that is measured by the terminal device is less than or equal to an RSSI threshold.

Step 506: When determining that the terminal device needs to provide a feedback for the first multicast service, the terminal device sends the first feedback information to the network device, where the first feedback information corresponds to the first multicast service.

Specifically, the first feedback information sent by the terminal device to the network device may be positive feedback information, for example, an acknowledgment (ACK), or may be a negative acknowledgment (NACK). For example, if the terminal device correctly receives the first multicast service, the terminal device needs to send the positive feedback information (the ACK) to the network device. If the terminal device does not correctly receive the first multicast service, the terminal device needs to send negative feedback information (the NACK) to the network device.

For example, from a perspective of the network device, the network device determines, based on the received first feedback information corresponding to the first multicast service, a mode (a unicast mode or a multicast mode) for resending the first multicast service. In an example, if a quantity of pieces of received NACK feedback information corresponding to the first multicast service is less than or equal to a threshold (where the threshold is a positive integer greater than or equal to 1), the network device resends, in the unicast mode, the first multicast service to each terminal that feeds back the NACK information. Otherwise, the network device resends the first multicast service in the multicast mode. In another example, the network resends the first multicast service in the multicast mode only when receiving NACK feedback information corresponding to the first multicast service.

The following describes possible implementations in which the terminal device sends the first feedback information to the network device.

In a possible embodiment, the first indication information indicates the transmission resource of the first feedback information of the first multicast service. In this case, the terminal device may send the first feedback information to the network device on the transmission resource.

In another possible embodiment, the first indication information does not indicate the transmission resource of the first feedback information of the first multicast service, but the terminal device receives resource indication information from the network device, where the resource indication information indicates a transmission resource configured by the network device for the terminal device. In this case, the terminal device transmits the first feedback information on the transmission resource configured by the network device.

In still another possible embodiment, the first indication information does not indicate the transmission resource of the first feedback information of the first multicast service. In this case, the terminal device may send the first feedback information to the network device on a transmission resource that is agreed on in the protocol.

In the foregoing embodiment, for the terminal device, the network device may configure a PUCCH resource corresponding to the first feedback information, and the terminal device may send the first feedback information on the PUCCH resource. The terminal device may further receive a unicast service from the network device, and the terminal device further needs to provide a feedback for the unicast service. Consequently, a conflict may occur between a PUCCH resource used for HARQ feedback on the unicast service and the PUCCH resource used for the first feedback information. To resolve this problem, when a feedback resource of the first multicast service conflicts with a feedback resource of the unicast service, the terminal device may determine, based on a priority of feedback information, whether to send the first feedback information of the first multicast service to the network device. Specifically, the terminal device may determine, in either of the following two manners, how to provide feedbacks for the first multicast service and the unicast service.

Manner 1: The priority is predefined in the protocol.

Specifically, if it is agreed on in advance in the protocol that a priority of feedback information of a multicast service is higher than a priority of feedback information of a unicast service, the terminal device may preferentially send the first feedback information corresponding to the first multicast service to the network device, and discard feedback information corresponding to the unicast service. If it is agreed on in advance in the protocol that a priority of feedback information of a multicast service is not higher than a priority of feedback information of a unicast service, the terminal device preferentially sends feedback information corresponding to the unicast service to the network device, and discards the first feedback information corresponding to the first multicast service.

Manner 2: The priority is indicated by the network device by using third indication information.

Specifically, the terminal device may receive the third indication information from the network device, where the indication information is for indicating a priority of the feedback information of the multicast service. The third indication information may be carried together with the multicast configuration information in DCI or an RRC message. In response to the third indication information, if the third indication information indicates that the priority of the feedback information of the first multicast service is a first priority (for example, a high-level priority), the terminal device preferentially sends the first feedback information corresponding to the first multicast service to the network device, and discards feedback information corresponding to the unicast service. If the third indication information indicates that the priority of the feedback information of the first multicast service is a second priority (for example, a low-level priority), the terminal device preferentially sends feedback information corresponding to the unicast service to the network device, and discards the first feedback information corresponding to the first multicast service.

Optionally, the third indication information may be indicated by using one bit or a plurality of bits. This is not limited herein. For example, when the third indication information is indicated by using one bit, if the bit is set to “0”, the bit identifies the first priority; if the bit is set to “1”, the bit identifies the second priority.

Optionally, the terminal device receives an information frame that is sent by the network device through a physical downlink control channel, where the information frame is downlink control information in format 1_0 or format 1_1, and the information frame includes the third indication information.

Optionally, in Embodiment 1, after step 506 is performed, the method may further include step 507a: The terminal device determines to stop providing a feedback for the first multicast service. Implementations in which the terminal device determines to stop sending the feedback information for the first multicast service include an implementation 1a and an implementation 2a.

### Implementation 1a

The terminal device determines, based on fourth indication information sent by the network device, to stop sending the feedback information for the first multicast service. Correspondingly, step 507a may specifically include step 507 and step 508.

Step 507: The network device sends the fourth indication information to the terminal device, where the fourth indication information is for indicating the terminal device to stop sending the feedback information for the first multicast service.

For example, the fourth indication information may be carried in DCI, an RRC message, or a media access control (media access control, MAC) control element (control element, CE).

Optionally, the method further includes step 508: The terminal device sends feedback stopping acknowledgment information to the network device, where the feedback stopping acknowledgment information is for indicating that the terminal device stops sending the feedback information for the first multicast service.

### Implementation 2a

Step 507a may be specifically as follows: The terminal device determines, based on a predefined parameter, to stop providing a feedback for the first multicast service. The predefined parameter may be duration of a first timer or a first count threshold.

In an example, the predefined parameter is the duration of the first timer. If the terminal device triggers starting of the first timer by sending the feedback information, when the first timer expires, the terminal device determines to stop providing a feedback for the first multicast service. When the terminal device subsequently sends the first feedback information on the feedback resource corresponding to the first multicast service, the terminal device triggers restarting of the first timer. When the first timer expires, the terminal device determines to stop providing a feedback for the first multicast service.

In another example, the predefined parameter is the first count threshold. The first count threshold corresponds to a first counter, and an initial value of the first counter is 0. If content transmitted by the terminal device on the feedback resource corresponding to the first multicast service does not include the first feedback information, the value of the first counter is increased by 1. When the value of the first counter is greater than or equal to the first count threshold, the terminal device determines to stop providing a feedback for the first multicast service. In addition, if the content transmitted by the terminal device on the feedback resource corresponding to the first multicast service includes the first feedback information, the counter is reset.

In addition, according to the implementation 1a and the implementation 2a, once the terminal device determines to stop sending the feedback information for the first multicast service, the terminal device performs at least one of the following actions: Action 1: Stop sending the feedback information for the first multicast service. Action 2: Release the PUCCH resource configured for multicast feedback, to further improve resource utilization. Action 3: Indicate, to an upper layer, that feedback corresponding to the first multicast service has been stopped. The network device configures a feedback function and the feedback resource for the terminal device. However, if the terminal device does not use the feedback resource for a long time, a waste of communication resources is caused. According to the communication method provided in this embodiment, a feedback resource with low utilization can be released in time, so that resource utilization of a communication system can be improved.

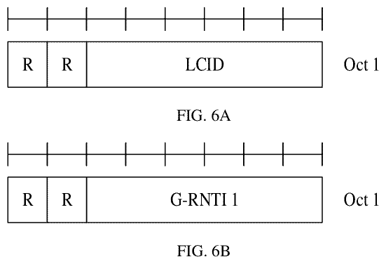

In a possible embodiment, in step 508, the feedback stopping acknowledgment information may be carried in a MAC CE. Each MAC CE has a corresponding MAC subheader, the MAC subheader includes a logical channel identifier (logical channel identifier, LCID), and the LCID is for identifying a corresponding MAC CE type. For the MAC subheader, refer to FIG. 6A. There are the following two possible implementations that correspond to different MAC CE formats:

### Manner I:

A length of the MAC CE corresponding to the feedback stopping acknowledgment information is 0, and the MAC CE is indicated by the logical channel identifier LCID. For example, if the LCID takes a first preset value, it indicates that the terminal device stops sending the feedback information for the first multicast service.

In another possible manner, the feedback stopping acknowledgment information may be indicated by the length of the MAC CE. For example, if the length of the MAC CE is a first preset length, the MAC CE with the first preset length is for indicating that sending of the feedback information for the first multicast service is stopped.

### Manner II:

The feedback stopping acknowledgment information may be indicated by fifth indication information in the MAC CE. The fifth indication information may be the G-RNTI 1 associated with the first multicast service, or a service identifier of the first multicast service. For example, with reference to FIG. 6B, when the MAC CE carries the G-RNTI 1, it indicates that the terminal device stops providing a feedback for the first multicast service corresponding to the G-RNTI 1.

It can be learned from the foregoing content that, in an aspect, the terminal device may provide a feedback for the multicast service; in another aspect, the terminal device may provide a feedback for the first multicast service based on the first indication information, and the network device may indicate, by using the first indication information, the terminal device to provide a feedback for the multicast service that has a high latency requirement, so that reliability of the multicast service with the high latency requirement can be effectively improved, and configuration flexibility can be improved.

### Embodiment 2

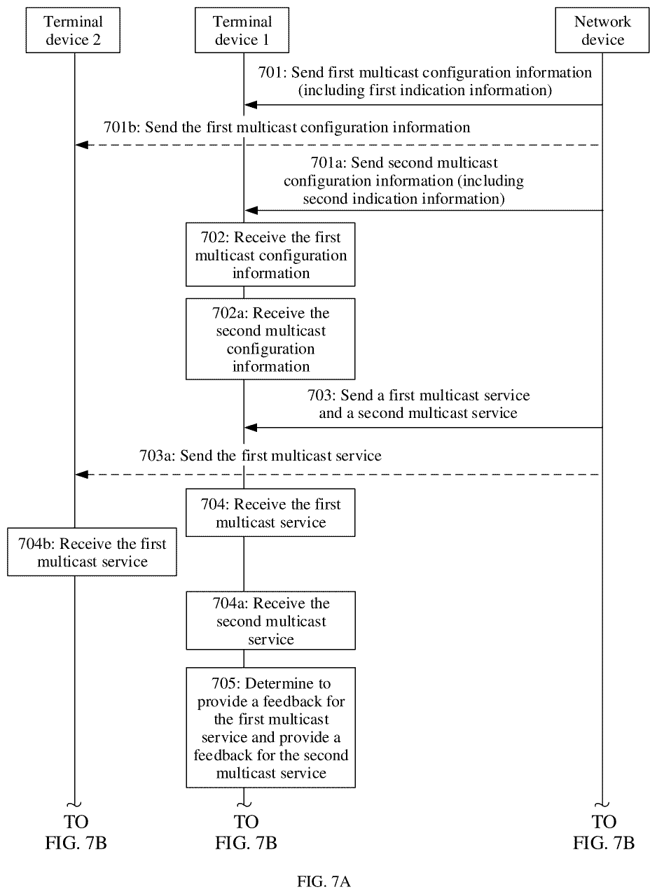

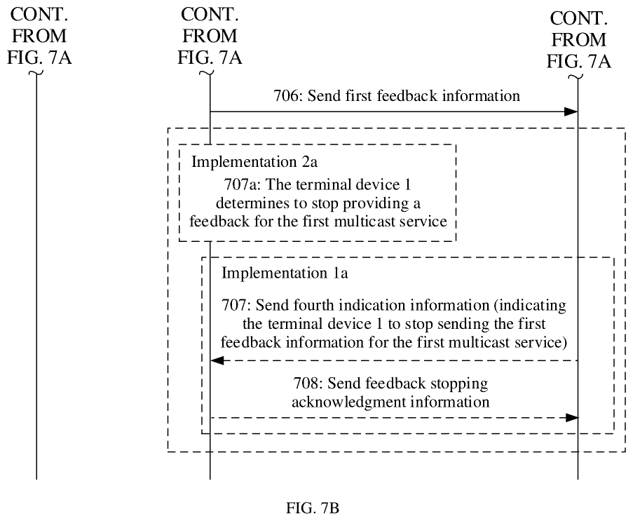

As shown in FIG. 7A and FIG. 7B, the communication method provided in embodiments of this application may further implement a feedback mechanism applicable to a plurality of multicast services, and a network device may configure different feedback functions and/or feedback resources for different multicast services. The terminal device 1 in FIG. 4A is used as an example. The method may include the following steps.

Step 701: The network device sends first multicast configuration information to the terminal device 1, where the first multicast configuration information corresponds to a first multicast service, the first multicast configuration information includes first indication information, and the first indication information is for indicating to send first feedback information for the first multicast service.

The first multicast configuration information is for indicating the terminal device to receive the first multicast service. The first multicast configuration information may be carried in an RRC message, system information, or a common channel. The first multicast configuration information is multicast configuration information corresponding to the first multicast service. For specific content of multicast configuration information and specific content that may be further included in the first multicast configuration information, refer to step 501. Details are not described herein again.

Step 701a: The network device sends second multicast configuration information to the terminal device 1, where the second multicast configuration information corresponds to a second multicast service, the second multicast configuration information includes second indication information, and the second indication information is for indicating that the terminal device 1 does not need to send feedback information for the second multicast service.

The second multicast configuration information is for indicating the terminal device to receive the second multicast service. The first multicast configuration information may be carried in an RRC message. For specific content included in the first multicast configuration information, refer to step 501. Details are not described herein again.

For example, the first multicast service and the second multicast service in step 701 and step 701a are different multicast services. The following separately provides descriptions for two manners.

Manner A: The first multicast configuration information and the second multicast configuration information may be carried in different messages. For example, the first multicast configuration information is carried in a first RRC message, and the second multicast configuration information may be carried in a second RRC message. The network device separately sends the first RRC message and the second RRC message to the terminal device. The first multicast configuration information in the first RRC message indicates the terminal device 1 to receive the first multicast service, and the second multicast configuration information in the second RRC message indicates the terminal device 2 to receive the second multicast service.

Manner B: The first multicast configuration information and the second multicast configuration information are carried in a same message. For example, the network device sends a third RRC message to the terminal device, where the third RRC message includes the first multicast configuration information and the second multicast configuration information, the first multicast configuration information corresponds to the first multicast service, the second multicast configuration information corresponds to the second multicast service, the first multicast configuration information includes the first indication information, and the second multicast configuration information includes the second indication information.

In a possible embodiment, in step 701 and step 701a, the network device may indicate, in the first indication information and/or the second indication information by using an explicit indication method or an implicit indication method, whether the terminal device needs to send the feedback information. For details, refer to the three manners of the first indication information in the foregoing step 501. Details are not described herein again.

It should be noted that the first indication information and the second indication information that are sent by the network device may indicate, in a same manner in the three manners in the foregoing step 501, whether the terminal device 1 provides feedbacks, or may indicate, in different manners, whether the terminal device 1 provides feedbacks. This is not limited in this embodiment of this application.

Step 702: The terminal device 1 receives the first multicast configuration information.

Step 702a: The terminal device 1 receives the second multicast configuration information.

In step 702 and step 702a, that the terminal device 1 receives the first multicast configuration information and the second multicast configuration information that are sent by the network device includes cases shown in the following examples.

In an example, the terminal device 1 may receive the first multicast configuration information and the second multicast configuration information from the network device by using a radio resource control (radio resource control, RRC) connection message.

In another example, the terminal device 1 may receive the first multicast configuration information and the second multicast configuration information from the network device by using a common channel or system information.

In still another example, the terminal device 1 may receive the first multicast configuration information and the second multicast configuration information from the network device in a random access procedure.

Step 703: The network device sends the first multicast service and the second multicast service to the terminal device 1.

It should be noted that the first multicast service and the second multicast service may be sent in a same message, or may be separately sent.

Step 704: The terminal device 1 receives the first multicast service based on the first multicast configuration information.

In a possible implementation, when the first multicast configuration information further includes a G-RNTI 1 associated with the first multicast service in addition to the first indication information, the terminal device 1 may descramble, based on the G-RNTI 1 in the first RRC message, DCI 1 that is from the network device, and further receive the first multicast service carried on a multicast PDSCH 1, where the DCI 1 is for scheduling the multicast PDSCH 1.

Step 704a: The terminal device 1 receives the second multicast service based on the second multicast configuration information.

For step 704 and step 704a, the terminal device may receive the first multicast configuration information and/or the second multicast configuration information in either of the following manners.

For the manner A in step 701 and step 701a: In an aspect, the terminal device 1 may descramble, based on the G-RNTI 1 in the first RRC message, the DCI 1 that is from the network device, and further receive the first multicast service carried on the multicast PDSCH 1, where the DCI 1 is for scheduling the multicast PDSCH 1. In another aspect, the terminal device 1 may descramble, based on a G-RNTI 2 in the second RRC message, DCI 2 that is from the network device, and further receive the second multicast service carried on a multicast PDSCH 2, where the DCI 2 is for scheduling the multicast PDSCH 2.

For the manner B in step 701 and step 701a, the terminal device 1 may descramble, based on a G-RNTI in the third RRC message, DCI that is from the network device, and further receive the first multicast service carried on a multicast PDSCH 1 and the second multicast service carried on a multicast PDSCH 2, where the DCI is for scheduling the multicast PDSCH 1 and the multicast PDSCH 2.

Step 705: The terminal device 1 may determine, based on the first indication information, whether to provide a feedback for the first multicast service, and determine, based on the second indication information, whether to provide a feedback for the second multicast service. If yes, the terminal device 1 performs the subsequent step 706. Otherwise, the terminal device 1 stops performing the subsequent step.

Specifically, according to any one or more manners listed in step 505, the terminal device 1 may determine, based on the first indication information, whether to provide a feedback for the first multicast service, and determine, based on the second indication information, whether to provide a feedback for the second multicast service. Details are not described herein again.

Step 706: The terminal device 1 sends the first feedback information to the network device, where the first feedback information corresponds to the first multicast service.

The terminal device 1 sends the first feedback information to the network device, where the first feedback information may be an ACK or a NACK. For example, if the terminal device 1 correctly receives the first multicast service, the terminal device 1 needs to send positive feedback information (the ACK) to the network device. If the terminal device 1 does not correctly receive the first multicast service, the terminal device 1 needs to send negative feedback information (the NACK) to the network device.

For example, from a perspective of the network device, the network device determines, based on the received first feedback information corresponding to the first multicast service, a mode (a unicast mode or a multicast mode) for resending the first multicast service. In an example, if a quantity of pieces of received NACK feedback information corresponding to the first multicast service is less than or equal to a threshold (where the threshold is a positive integer greater than or equal to 1), the network device resends, in the unicast mode, the first multicast service to each terminal that feeds back the NACK information. Otherwise, the network device resends the first multicast service in the multicast mode. In another example, the network resends the first multicast service in the multicast mode only when receiving NACK feedback information corresponding to the first multicast service.

For several possible implementations in which the terminal device sends the first feedback information to the network device, refer to the implementations after step 506. Details are not described herein again.

In a possible embodiment, for a same multicast service, the network device may indicate at least one terminal device in a group of terminal devices to provide a feedback for the multicast service, and indicate at least one terminal device in the same group of terminal devices not to provide a feedback for the multicast service. Based on this, the communication method shown in FIG. 7A and FIG. 7B may further include the following step 701b, step 703a, and step 704b. In this embodiment, after receiving the first multicast service, a terminal device 2 does not provide a feedback for the first multicast service.

Step 701b: The network device sends third multicast configuration information to the terminal device 2, where the third multicast configuration information corresponds to the multicast service, the third multicast configuration information includes indication information, and the indication information is for indicating that the terminal device 2 does not need to provide a feedback for the first multicast service.

A first group of terminal devices include the terminal device 1 and the terminal device 2, as shown in FIG. 4A.

Step 703a: The network device sends the first multicast service to the terminal device 2.

In a possible implementation, the network device may send the first multicast service to the terminal device 1 and the terminal device 2 in the first group of terminal devices in the multicast mode.

Step 704b: The terminal device 2 receives the first multicast service.

In a possible embodiment, before performing step 701, the network device needs to determine the terminal device that needs to provide a feedback for the multicast service. A determining method used by the network device may include one or more of the following manners.

Manner 1: The network device may determine, based on a service requirement of a group of terminal devices to which a terminal device belongs, whether a multicast service sent by the network device to the terminal device is a multicast service that the terminal device is interested in. If yes, the network device determines that the terminal device needs to provide a feedback for the multicast service.

For example, in the foregoing embodiment, a group of terminal devices to which the terminal device 1 belongs is the first group of terminal devices in FIG. 4A. It is assumed that a service requirement of the first group of terminal devices for the first multicast service is a high reliability requirement. In a possible manner, the network device determines that a terminal device that is in the first group of terminal devices and that receives the first multicast service needs to provide a feedback for the first multicast service. To be specific, the network device may configure the terminal device 1 in the first group of terminal devices to provide a feedback for the first multicast service, and configure the terminal device 2 not to provide a feedback for the first multicast service. In another possible manner, the network device may determine that all terminal devices in the first group of terminal devices need to provide feedbacks for the first multicast service.

For another example, it is assumed that a service requirement of the first group of terminal devices for the second multicast service is a low reliability requirement. In a possible manner, the network device may configure the terminal device 1 in the first group of terminal devices not to provide a feedback for the second multicast service.

Manner 2: The network device may determine, based on a physical relative distance between a terminal device and the network device, whether the terminal device needs to provide a feedback for a multicast service.

For example, if a physical distance between the terminal device 1 and the network device exceeds a specified threshold, the network device may indicate that the terminal device 1 needs to provide a feedback for the received first multicast service. On the contrary, if a physical distance between the terminal device 2 and the network device does not exceed the specified threshold, the network device may indicate that the terminal device 2 does not need to provide a feedback for the received first multicast service.

Manner 3: The network device may determine, based on a channel quality status of a terminal device, whether the terminal device needs to provide a feedback for a multicast service.

For example, the network device may determine a channel quality status of the terminal device based on a transmission channel (for example, a PDSCH) of the first multicast service. If channel quality of the terminal device 1 is poor, the network device may indicate that the terminal device 1 needs to provide a feedback for the received first multicast service. On the contrary, if channel quality of the terminal device 2 is good, the network device may indicate that the terminal device 2 does not need to provide a feedback for the received first multicast service.

For another example, the network device may determine a channel quality status of the terminal device based on a transmission channel (for example, a PDSCH) of the first multicast service and the second multicast service. If transmission channel quality of the terminal device 1 for the first multicast service is poor, the network device may indicate that the terminal device 1 needs to provide a feedback for the received first multicast service. If transmission channel quality of the terminal device 1 for the second multicast service is good, the network device may indicate that the terminal device 1 does not need to provide a feedback for the received second multicast service.

In a possible embodiment, in step 706, when a feedback resource of the first multicast service conflicts with a feedback resource of a unicast service, the terminal device 1 may determine, based on a priority of feedback information, whether to send the first feedback information of the first multicast service to the network device. For details, refer to the descriptions in the method shown in FIG. 5. Details are not described herein again.

In a possible embodiment, in Embodiment 1, after step 706 is performed, the method may further include step 707a: The terminal device determines to stop providing a feedback for the first multicast service. Implementations in which the terminal device 1 determines to stop sending the feedback information for the first multicast service are separately an implementation 1b and an implementation 2b.

### Implementation 1b

The terminal device 1 determines, based on fourth indication information sent by the network device, to stop sending the feedback information for the first service. Correspondingly, step 707a may specifically include step 707 and step 708.

Step 707: The network device sends the fourth indication information to the terminal device 1, where the fourth indication information is for indicating the terminal device 1 to stop sending the feedback information for the first multicast service.

For example, the fourth indication information may be carried in DCI, an RRC message, or a MAC CE.

Optionally, the method further includes step 708: The terminal device 1 sends feedback stopping acknowledgment information to the network device, where the feedback stopping acknowledgment information is for indicating that the terminal device 1 stops sending the feedback information for the first multicast service. In this way, the terminal device 1 releases a PUCCH resource configured for multicast feedback, so that resource utilization is improved.

### Implementation 2b

Step 507a may be specifically: The terminal device 1 determines, based on a predefined parameter, to stop providing a feedback for the first multicast service. The predefined parameter may be a first timer or a first count threshold. For details, refer to the foregoing implementation 2a. Details are not described herein again.

In addition, after the implementation 1b and the implementation 2b, once the terminal device determines to stop sending the feedback information for the first multicast service, the terminal device performs at least one of the following actions: Action 1: Stop sending the feedback information for the first multicast service. Action 2: Release the PUCCH resource configured for multicast feedback, to further improve resource utilization. Action 3: Indicate, to an upper layer, that feedback corresponding to the first multicast service has been stopped. It can be learned that, if the terminal device is configured with a feedback function and a feedback resource, but the terminal device does not use the feedback resource for a long time, the method can be used to avoid a waste of resources, to be specific, to help release the feedback resource in time.

In a possible embodiment, the feedback stopping acknowledgment information in step 708 may be carried in a MAC CE. Each MAC CE has a corresponding MAC subheader, the MAC subheader includes a logical channel identifier (logical channel identifier, LCID), and the LCID is for identifying a corresponding MAC CE type. For the MAC subheader, refer to FIG. 6A. For two possible implementations that correspond to different MAC CE formats, refer to the manner I and the manner II that are listed after step 508 in Embodiment 1.

In this embodiment of this application, the network device may configure different feedback functions and/or feedback resources for different multicast services. In an aspect, the terminal device may provide a feedback for the multicast service. In another aspect, because the first indication information indicates to provide a feedback for the first multicast service, the terminal device may provide a feedback for the multicast service that has a high latency requirement and that is indicated by the network device, so that reliability of the multicast service with the high latency requirement can be effectively improved.

### Embodiment 3

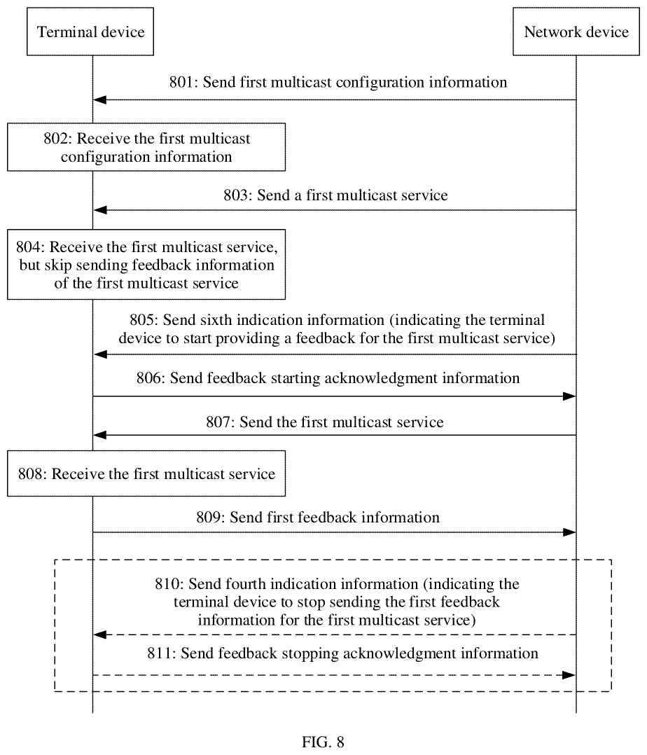

As shown in FIG. 8, a network device may dynamically control, by using indication information, a terminal device to enable or disable a feedback function. A method may include the following steps.

Step 801: The network device sends first multicast configuration information to the terminal device, where the first multicast configuration information corresponds to a first multicast service.

In a possible implementation, the first multicast configuration information may include configuration information of feedback information corresponding to the first multicast service. For example, the configuration information includes feedback timing duration of first feedback information of the first multicast service, a codebook used for the first feedback information, or a transmission resource for sending the first feedback information.

The first multicast configuration information is for indicating the terminal device to receive the first multicast service. The first multicast configuration information may be carried in an RRC message, system information, or a common channel. The first multicast configuration information is multicast configuration information corresponding to the first multicast service. For specific content of multicast configuration information and specific content that is further included in the first multicast configuration information, refer to step 501. Details are not described herein again.

Step 802: The terminal device receives the first multicast configuration information.

In an example, the terminal device may receive the first multicast configuration information from the network device through a radio resource control (radio resource control, RRC) connection.

In another example, the terminal device may receive the first multicast configuration information from the network device by using the common channel or the system information.

In still another example, the terminal device may receive the first multicast configuration information from the network device in a random access procedure.

Step 803: The network device sends the first multicast service to the terminal device.

Step 804: The terminal device receives the first multicast service based on the first multicast configuration information.

In a possible implementation, when the first multicast configuration information further includes a G-RNTI 1 associated with the first multicast service in addition to first indication information, the terminal device may descramble, based on the G-RNTI 1 in a first RRC message, DCI 1 that is from the network device, and further receive the first multicast service carried on a multicast PDSCH 1, where the DCI 1 is for scheduling the multicast PDSCH 1.

It is considered by default that the terminal device does not provide a feedback for a received multicast service. Therefore, after performing step 804, the terminal device does not provide a feedback for the currently received first multicast service.

Step 805: The network device sends sixth indication information to the terminal device, where the sixth indication information is for indicating the terminal device to start sending the feedback information for the first multicast service.

For example, the sixth indication information may be carried in DCI, an RRC message, or a MAC CE.

Step 806: The terminal device sends feedback starting acknowledgment information to the network device, where the feedback starting acknowledgment information is for indicating that the terminal device starts to send the feedback information for the first multicast service.

The feedback starting acknowledgment information may be carried in a MAC CE. Each MAC CE has a corresponding MAC subheader, the MAC subheader includes an LCID, and the LCID is for identifying a corresponding MAC CE type. For the MAC subheader, refer to FIG. 6A. There are the following two possible implementations that correspond to different MAC CE formats:

### Manner A:

The feedback starting acknowledgment information may be indicated by an LCID. For example, if the LCID takes a second preset value (for example, a quantity of bytes is 1), it indicates that the terminal device starts to send the feedback information for the first multicast service.

### Manner B:

The feedback starting acknowledgment information may be indicated by a length of the MAC CE. For example, if the length of the MAC CE is a second preset length, the MAC CE with the second preset length is for indicating that the terminal device starts to send the feedback information for the first multicast service.

### Manner C:

The feedback starting acknowledgment information may be indicated by indication information in the MAC CE. The indication information may be an identifier of the terminal device, an identifier of the first multicast service, or the like.

Step 807: The network device sends the first multicast service to the terminal device.

Step 808: The terminal device continues to receive the first multicast service.

Step 809: The terminal device sends the first feedback information to the network device, where the first feedback information corresponds to the first multicast service.

The first feedback information sent by the terminal device to the network device may be positive feedback information (an ACK) or negative feedback information (a NACK). For details, refer to step 506. Details are not described herein again.

Step 810: The network device sends fourth indication information to the terminal device, where the fourth indication information is for indicating the terminal device to stop sending the feedback information for the first multicast service.

For example, the fourth indication information may be carried in DCI, an RRC message, or a MAC CE.

Step 811: The terminal device sends feedback stopping acknowledgment information to the network device, where the feedback stopping acknowledgment information is for indicating that the terminal device stops sending the feedback information for the first multicast service.

In this way, after performing step 811, the terminal device no longer provides a feedback for the first multicast service. Therefore, a PUCCH resource configured for multicast feedback is released, and resource utilization is improved. For specific examples, refer to the foregoing implementation 1a and implementation 2a. Details are not described herein again.

In this embodiment of this application, the network device may indicate, by using the sixth indication information, the terminal device to enable a feedback function for the first multicast service, and indicate, by using the fourth indication information, the terminal device to stop providing a feedback for the first multicast service, to implement flexible control of the feedback function, and configure the feedback function for the multicast service based on a real-time service requirement. Therefore, service reliability of a communication system is improved, and resource utilization is ensured.

### Embodiment 4

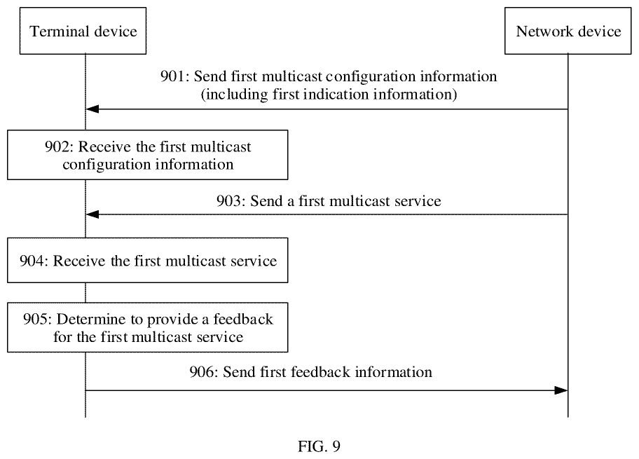

In a scenario, in Embodiment 1, in which the first indication information of the first multicast configuration information is the signal quality parameter threshold, the network device sends the signal quality parameter threshold, so that the terminal device may determine, based on transmission quality of the multicast service, whether to send the feedback information. In this embodiment of this application, how a terminal device provides a feedback for a first multicast service in this scenario is further described in detail by using a method flowchart shown in FIG. 9.

Step 901: A network device sends first multicast configuration information to the terminal device, where the first multicast configuration information corresponds to the first multicast service, the first multicast configuration information includes first indication information, the first indication information includes a signal quality parameter threshold corresponding to the first multicast service, and the first indication information is for indicating to send first feedback information for the first multicast service.

It should be noted that the first multicast configuration information is for indicating the terminal device to receive the first multicast service. The first multicast configuration information may be carried in an RRC message, system information, or a common channel. The first multicast configuration information is multicast configuration information corresponding to the first multicast service.

In addition, it should be noted that in step 901, the first multicast configuration information may alternatively not include the first indication information, that is, the first indication information (that is, the signal quality parameter threshold) may be independently carried in another RRC message, other system information, or another common channel.

For example, a signal quality parameter may be RSRP, an SINR, or RSRQ. The signal quality parameter threshold may be an RSRP threshold, an SINR threshold, an RSRQ threshold, or the like. For specific content of multicast configuration information and specific content of the first multicast configuration information, refer to step 501 in FIG. 5. Details are not described again in this embodiment of this application.

Step 902: The terminal device receives the first multicast configuration information.

Step 903: The network device sends the first multicast service to the terminal device.

Step 904: The terminal device receives the first multicast service based on the first multicast configuration information.

In a possible implementation, when the first multicast configuration information further includes a G-RNTI 1 associated with the first multicast service in addition to the first indication information, the terminal device may descramble, based on the G-RNTI 1, DCI 1 that is from the network device, and further receive the first multicast service carried on a multicast PDSCH 1, where the DCI 1 is for scheduling the multicast PDSCH 1.

Step 905: The terminal device compares a value of a signal quality parameter of the first multicast service and the threshold, to determine whether to provide a feedback for the first multicast service. If yes, the terminal device performs the subsequent step 906. Otherwise, the terminal device stops performing the subsequent step.

Specifically, when the value of the signal quality parameter of the first multicast service is less than or equal to the threshold, the terminal device determines that the terminal device needs to provide a feedback for the first multicast service; when the value of the signal quality parameter of the first multicast service is greater than the threshold, the terminal device determines that the terminal device does not need to provide a feedback for the first multicast service.

For example, the terminal device may determine, based on at least one or a plurality of the following conditions, that the terminal device needs to provide a feedback for the first multicast service. Condition 1: The terminal device determines that an RSRP value of the first multicast service is less than or equal to the RSRP threshold. Condition 2: The terminal device determines that an RSRQ value of the first multicast service is less than or equal to the RSRQ threshold.

Condition 3: The terminal device determines that an SINR value of the first multicast service is less than or equal to the SINR threshold. Condition 4: The terminal device determines that a CQI value of the first multicast service is less than or equal to a CQI threshold. Condition 5: The terminal device determines that an RSSI value of the first multicast service is less than or equal to an RSSI threshold.

Step 906: If determining that the terminal device needs to provide a feedback for the first multicast service, the terminal device sends the first feedback information corresponding to the first multicast service to the network device.

It can be learned that in this embodiment of this application, the terminal device may determine, based on the value of the signal quality parameter of the first multicast service, whether to provide a feedback, and provide a feedback only when signal quality of the received first multicast service is poor or not good. This can effectively improve reliability of the multicast service, and improve resource utilization of a communication system.

### Embodiment 5

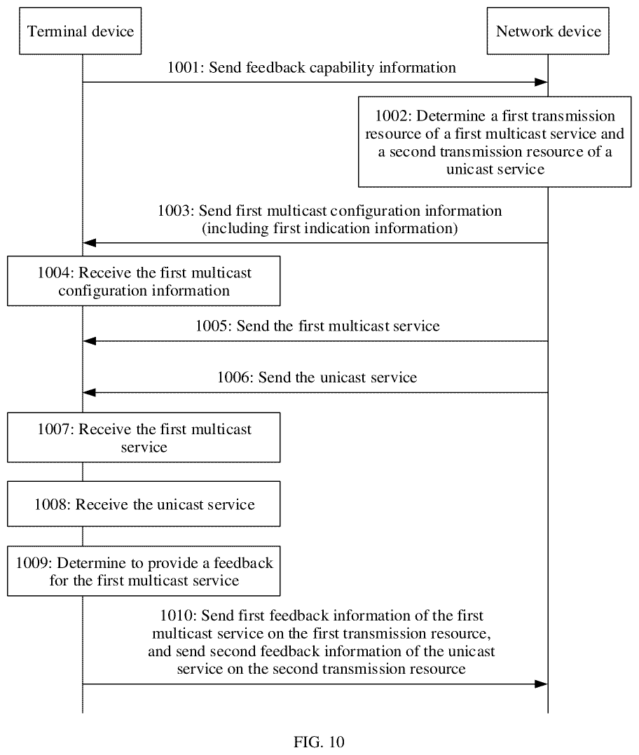

As shown in FIG. 10, according to a communication method provided in this embodiment of this application, a network device may indicate feedback functions and/or feedback resources of both a unicast service and a multicast service. The terminal device in FIG. 4A is used as an example. The method may include the following steps.

Step 1001: The terminal device sends feedback capability information to the network device, where the feedback capability information is for indicating a capability of sending unicast feedback information and multicast feedback information on a same feedback resource.

Specifically, the terminal device indicates, in the feedback capability information, that the terminal device does not support simultaneous sending of feedback information of a unicast service and feedback information of a multicast service on a same feedback resource (for example, in a same time sequence).

Step 1002: The network device determines, based on the feedback capability information of the terminal device, a first transmission resource of first feedback information corresponding to a first multicast service of the terminal device and a second transmission resource of feedback information corresponding to a unicast service.

In this embodiment of this application, when the feedback capability information indicates that the terminal device does not support providing feedbacks for a unicast service and a multicast service on a same feedback resource, the first transmission resource and the second transmission resource that are configured by the network device do not conflict with each other. For example, the first transmission resource and the second transmission resource are resources in different time sequences.

Step 1003: The network device sends first multicast configuration information to the terminal device, where the first multicast configuration information corresponds to the first multicast service, the first multicast configuration information includes first indication information, and the first indication information is for indicating to send the first feedback information for the first multicast service. The first indication information may further indicate the first transmission resource and the second transmission resource.

The first multicast configuration information is for indicating the terminal device to receive the first multicast service. The first multicast configuration information may be carried in an RRC message, system information, or a common channel. The first multicast configuration information is multicast configuration information corresponding to the first multicast service. For specific content of multicast configuration information and specific content that may be further included in the first multicast configuration information, refer to step 501. Details are not described herein again.

Step 1004: The terminal device receives the first multicast configuration information.

In an example, the terminal device may receive the first multicast configuration information from the network device through a radio resource control (radio resource control, RRC) connection.

In another example, the terminal device may receive the first multicast configuration information from the network device by using the common channel or the system information.

In still another example, the terminal device may receive the first multicast configuration information from the network device in a random access procedure.

Step 1005: The network device sends the multicast service to the terminal device.

Optionally, the method further includes step 1006: The network device sends the unicast service to the terminal device.

Step 1007: The terminal device receives the first multicast service based on the first multicast configuration information.

Optionally, when step 1006 is performed, the method further includes step 1008: The terminal device receives the unicast service.

Step 1009: After receiving the first multicast service, the terminal device determines, based on the first indication information, whether to provide a feedback for the first multicast service. If yes, the terminal device performs the subsequent step 1010. Otherwise, the terminal device does not perform step 1010.

The terminal device may determine, based on the first indication information by using any one or more manners listed in step 505 in FIG. 5, whether to provide a feedback for the first multicast service. Details are not described herein again.

Step 1010: The terminal device sends the first feedback information of the first multicast service on the first transmission resource, and sends the feedback information of the unicast service on the second transmission resource.

In this embodiment of this application, the terminal device reports, to the network device, a capability indicating whether the terminal device supports sending feedback information of a unicast service and feedback information of a multicast service on a same feedback resource, so that the network device may schedule time sequences for the feedback information of the unicast service and the feedback information of the multicast service based on the feedback capability. In this way, a time sequence conflict between feedback of the unicast service and feedback of the multicast service of a same terminal device is avoided.

### Embodiment 6

Currently, a radio frame in LTE FDD is divided into 10 subframes (subframe), and each subframe has a length of 1 ms. Different subcarrier spacings correspond to different slot lengths and different relationships between a slot and a subframe in frame structures. For details, refer to the following Table 1:

TABLE 1
Subcarrier spacing, subframe, slot,
and quantity of slots per subframe

| | Subcarrier | Subframe length | Time/ | Quantity |
|---|---|---|---|---|
| Sequence | spacing SCS Δf | T_{subframe} | Slot Tₛ | of slots per |
| number | (kHz) | (ms) | (ms) | subframe |
| 1 | 2.5/7.5/15 | 1 ms | 0.5 ms | 2 |
| 2 | 1.25 | 1 ms | 1 ms | 1 |
| 3 | 0.37 | 1 ms | 3 ms | 1/3 |

Frame structures corresponding to the three sequence numbers (the sequence number 1, the sequence number 2, and the sequence number 3) in the foregoing table are respectively described as follows:

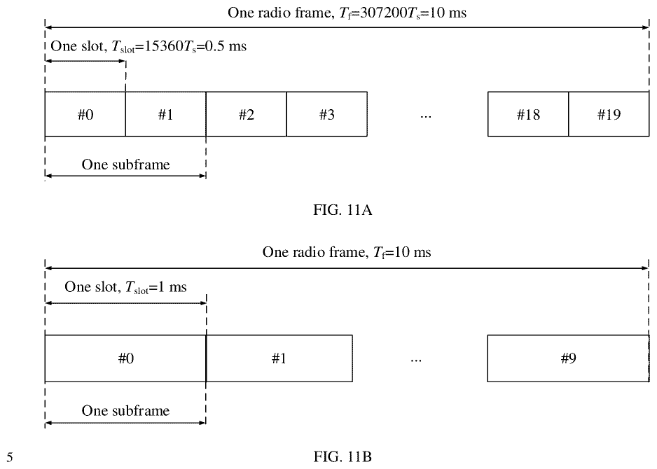

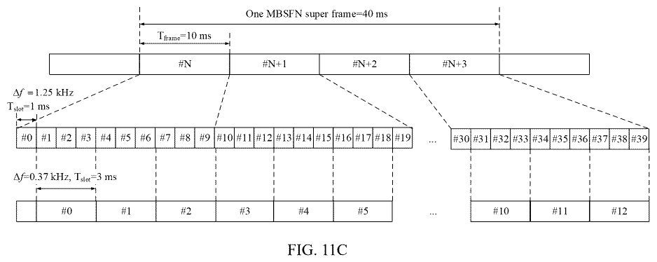

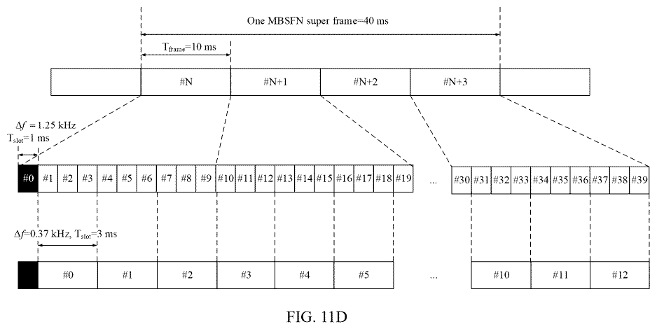

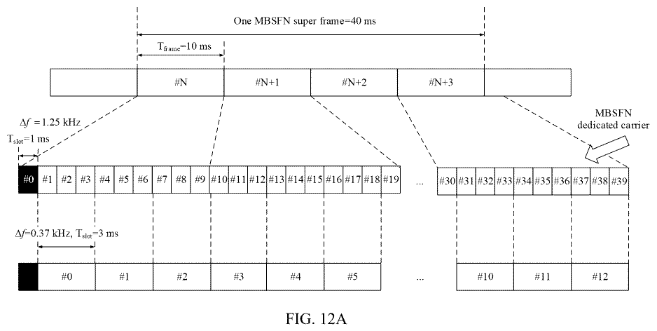

(1) A frame structure corresponding to Jf={2.5 kHz/7.5 kHz/15 kHz} is shown in FIG. 11A, where one frame is equal to 10 ms, one frame is equal to 10 subframes, and one subframe includes two slots. For 2.5 kHz, a length of each slot is 0.5 ms, and each slot includes one OFDM symbol with a CP.

(2) A frame structure corresponding to Δf=1.25 kHz is shown in FIG. 11B, where one frame is equal to 10 ms, one frame is equal to 10 subframes, one subframe is equal to one slot, and one subframe is equal to 1 ms.

(3) A frame structure corresponding to Δf=0.37 kHz is shown in FIG. 11C, where a time length of each slot is 3 ms, and each slot includes one OFDM symbol with a CP. In a start 40-ms interval that satisfies a condition n_{f} mod 4=0, there are 13 slots in total, where the 13 slots are numbered in ascending order from 0 to 12, and a position of a slot 0 in the 40-ms interval starts from 30720 Tₛ, n_{f} is a radio frame number, and Tₛ is a basic time unit.

Currently, an existing MBSFN configuration process is as follows: A network device configures, by using an information element (Information Element, IE) multimedia broadcast multicast service network subframe configuration (MBSFN-SubframeConfig), a subframe that is in a network and that can be reserved for multimedia broadcast multicast service network (multimedia broadcast multicast service network, MBSFN) in downlink. In the MBSFN-SubframeConfig configuration, the network device configures, by using radioframeAllocationPeriod (radioframeAllocationPeriod) and radioframeAllocationOffset (radioframeAllocationOffset), radio frames in which MBSFN subframes are located, and then indicates, by using subframeAllocation (subframeAllocation) and subframeAllocation-v1430 (subframeAllocation-v1430), specific subframes that are the MBSFN subframes. For detailed configurations, refer to Table 2.

TABLE 2
-- ASN1START

| | |
|---|---|
| MBSFN-SubframeConfig ::= | SEQUENCE { |
| radioframeAllocationPeriod | ENUMERATED {n1, n2, n4, n8, n16, n32}, |
| radioframeAllocationOffset | INTEGER (0..7), |
| subframeAllocation | CHOICE { |
| oneFrame | BIT STRING (SIZE(6)), |
| fourFrames | BIT STRING (SIZE(24)) |

}
}

| | |
|---|---|
| MBSFN-SubframeConfig-v1430 ::= | SEQUENCE { |
| subframeAllocation-v1430 | CHOICE { |
| oneFrame-v1430 | BIT STRING (SIZE(2)), |
| fourFrames-v1430 | BIT STRING (SIZE(8)) |

}
}
-- ASN1STOP

### In Table 2:

(1) radioFrameAllocationPeriod and radioFrameAllocationOffset are used to indicate a radio frame position at which an MBSFN subframe appears. When a formula SFN mod radioFrameAllocationPeriod=radioFrameAllocationOffset is satisfied, a corresponding radio frame is a radio frame that includes an MBSFN subframe, where SFN (System Frame Number) is a system frame number, n1 corresponds to a value 1, and n2 corresponds to a value 2.

(2) subframeAllocation is used to indicate specific subframes that are allocated as MBSFN subframes in the radio frame that satisfies the constraint formula of radioFrameAllocationPeriod and radioFrameAllocationOffset in (1).

(3) fourFrames: A string of bits are used to indicate a position of an MBSFN subframe in four consecutive radio frames. When a bit is set to “1”, it indicates a corresponding subframe is allocated for MBSFN. For FDD, subframes #1, #2, #3, #6, #7, and #8 may be allocated for MBSFN.

(4) fourFrames-v1430: A string of bits are used to indicate a position of an MBSFN subframe in four consecutive radio frames. For FDD, subframes #4 and #9 may also be configured as MBSFN subframes.

A problem existing in a current technology is: In a current MBSFN multicast mode, configuration is performed on a per-subframe (1 ms) basis (to be specific, specific subframes that may be used for an MBMS are indicated by using signaling). However, if the frame structure, shown in FIG. 11C, corresponding to Δf=0.37 kHz is introduced, a minimum unit that can be identified by a terminal device is one slot=3 ms, so that uncertainty exists when the terminal device configured with Δf=0.37 kHz determines a specific time domain position at which a resource that may be used for an MBMS is located.

This embodiment of this application provides a communication method. The method includes: For a terminal device (where Δf=1.25/2.5/7.5/15 kHz), the terminal device determines, based on MBSFN-SubframeConfig sent by a network device, specific subframes in time domain that are reserved by the network device for a downlink MBSFN service. However, if the terminal device is further configured with a subcarrier spacing Mf=0.37 kHz, that is, a corresponding minimum time unit is a slot=3 ms, when the terminal device determines specific time domain positions that are reserved by the base station for MBSFN in downlink, a determining method is different from an existing determining method.

Specifically, the terminal device is configured with a subcarrier spacing with a specific value, and the terminal device determines whether a minimum time unit corresponding to the subcarrier spacing is valid for MBSFN. A method for determining a valid minimum time unit includes: Only when an MBSFN subframe completely matches a minimum time unit corresponding to a subcarrier spacing with a specific value in time domain, or all u subframes corresponding to a minimum time unit corresponding to a subcarrier spacing with a specific value are used by the network device for MBSFN in downlink, the terminal device receives, in such a slot, an MBMS sent by the network device. For example, when Af=0.37 kHz, a quantity u of subframes corresponding to the minimum time unit is 3.

For example, it is considered that the network device can send an MBSFN service in a slot corresponding to Δf=0.37 kHz only when MBSFN subframes completely match the corresponding slot in time domain (that is, the MBSFN subframes and the slot overlap in time domain). For the terminal device configured with Af=0.37 kHz, only when all subframes corresponding to a slot are configured by the network device for MBSFN in downlink, the terminal device receives, in such a slot, an MBMS sent by the network device.

For example, as shown in FIG. 11D, the network device configures a subframe #1, a subframe #2, a subframe #3, a subframe #6, a subframe #7, and a subframe #8 as reserved subframes for MBSFN. However, for the terminal device configured with Δf=0.37 kHz (that is, for a frame structure corresponding to the last row), a beginning part (a black filled part) is a position used to send master system information and cannot be changed. Therefore, for UE configured with Δf=0.37 kHz, the subframes #1, #2, and #3 corresponding to a slot #0 are reserved by the network device for MBSFN in downlink, so that the slot #0 satisfies a condition, and the terminal device receives, in the slot #0, an MBMS sent by the base station. For a slot #1, because only the corresponding subframe #6 is an MBSFN subframe, but both a subframe #4 and a subframe #5 are non-MBSFN subframes, the terminal device does not receive, in the slot #1, an MBMS sent by the network device. Similarly, for a slot #2, the subframes #7 and #8 corresponding to the slot #2 are MBSFN subframes, but a subframe #9 is a non-MBSFN subframe. Therefore, for the terminal device configured with Af=0.37 kHz, the slot #2 is not reserved by the network device for MBSFN in downlink.

In this embodiment of this application, the terminal device determines an MBMS receiving position according to the foregoing method, so that the terminal device configured with Af=0.37 kHz can accurately determine a time domain resource corresponding to MBSFN in downlink.

It should be noted that a communication method corresponding to FIG. 11D may be implemented based on any possible implementation of Embodiment 1 to Embodiment 5.

### Embodiment 7

Based on the method for determining a valid slot in Embodiment 6, for a new feature introduced in R14 in the standard, that is, a carrier dedicated to an MBMS (which is also referred to as a dedicated MBMS carrier, dedicated MBMS carrier), this embodiment of this application provides another communication method based on this feature.

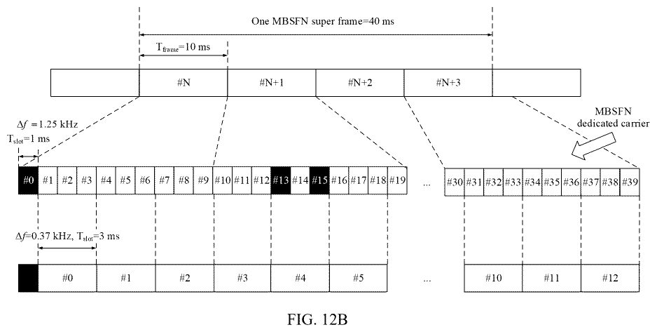

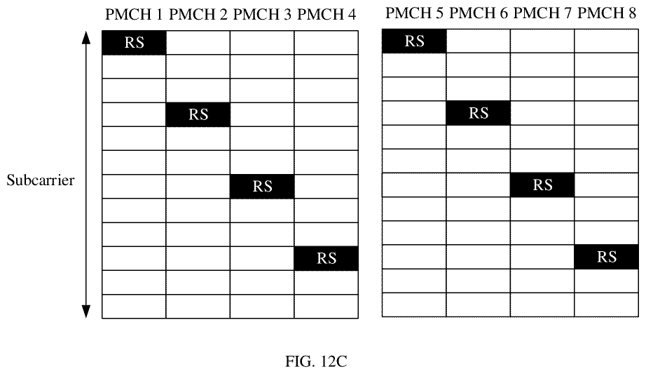

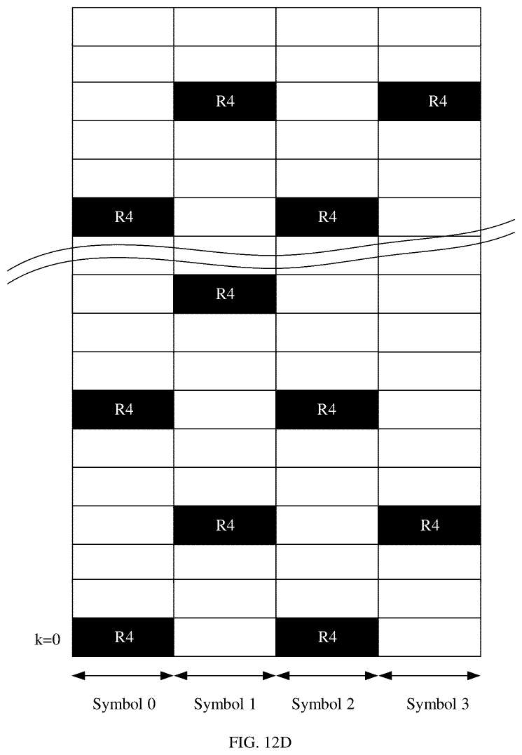

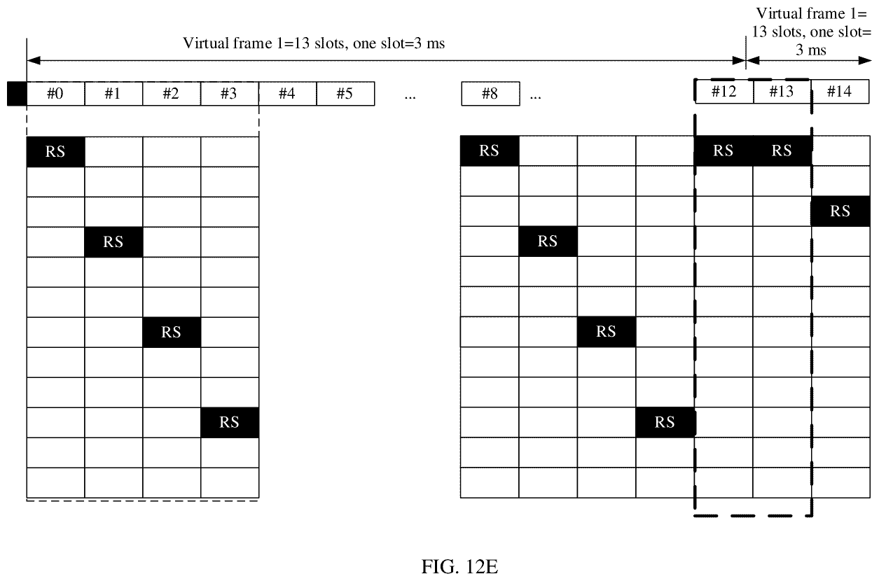

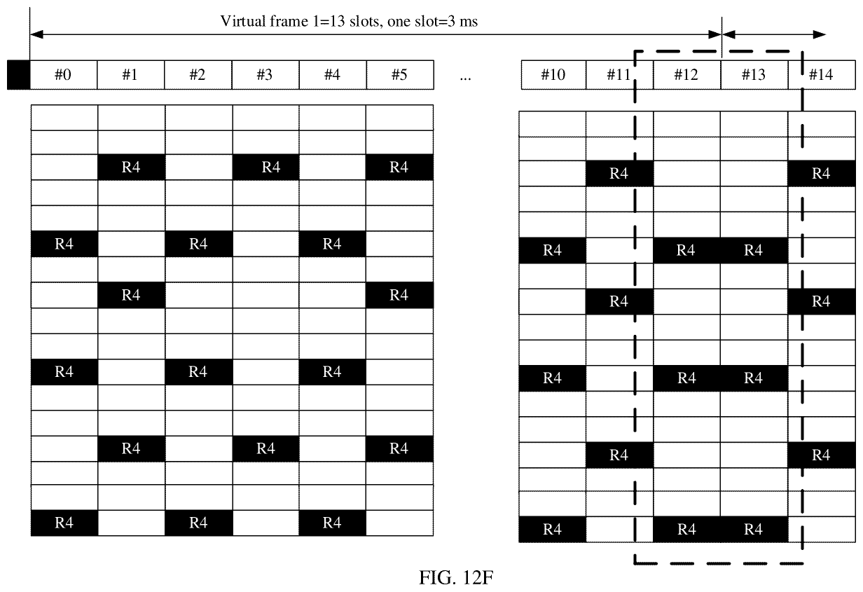

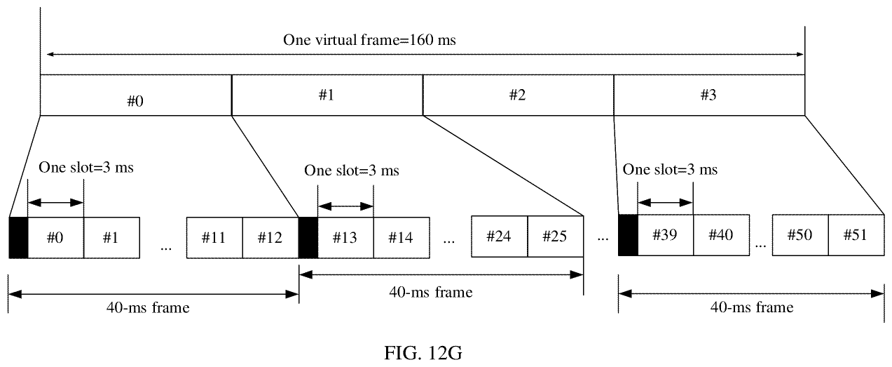

In this embodiment of this application, a dedicated frequency domain carrier is used to send an MBMS, but specific time domain positions that cannot be used to send the MBMS need to be indicated. FIG. 12A is a schematic diagram of a structure of a radio frame after the dedicated MBMS carrier is introduced. There is at least one non-MBSFN (non-MBSFN) subframe in every 40 ms, and the non-MBSFN subframe is used to send a PSS/SSS/CRS/PBCH/PDCCH and a PDSCH for sending system information.

If necessary, a broadcast message (a master system information block) may be used to indicate a quantity of additional non-MBSFN subframes after a non-MBSFN subframe #0. Optionally, the quantity of additional non-MBSFN subframes after the non-MBSFN subframe #0 may be 0, 1, 2, or 3, and a position of the additional non-MBSFN subframe may be further indicated in a system information block 1 (SIB 1). A specific indication may be configured by using a NonMBSFN-SubframeConfig-r14 (NonMBSFN-SubframeConfig-r14) field in the SIB 1, as shown in Table 3.

TABLE 3

| | |
|---|---|
| NonMBSFN-SubframeConfig-r14 ::= | SEQUENCE { |
| radioFrameAllocationPeriod-r14 | ENUMERATED {rf4, rf8, rf16, |

rf32, rf64, rf128, rf512},

| | |
|---|---|
| radioFrameAllocationOffset-r14 | INTEGER (0..7), |
| subframeAllocation-r14 | BIT STRING (SIZE(9)) |

}

radioFrameAllocationPeriod (radioFrameAllocationPeriod) and radioFrameAllocationOffset (radioFrameAllocationOffset) in the foregoing field are two parameters that are used to calculate a position of a radio frame in which a non-MBSFN subframe is located. The position of the radio frame (indicated by an SFN) including the non-MBSFN subframe satisfies the following formula: SFN mod radioFrameAllocationPeriod-radioFrameAllocationOffset.

SubframeAllocation is used to indicate a position of the non-MBSFN subframe in the radio frame that satisfies the foregoing formula. SubframeAllocation occupies nine bits, and a bit 1 to a bit 9 in the nine bits respectively correspond to a subframe 1 to a subframe 9. When a value of a bit is “0”, it indicates that a corresponding subframe is an MBSFN subframe. When a value of a bit is “1”, it indicates that a corresponding subframe is a non-MBSFN subframe.

As shown in FIG. 12A, a base station configures an MBSFN dedicated carrier, only a subframe #0 is configured as a non-MBSFN subframe, and there is no additional non-MBSFN subframe after the subframe #0. Therefore, for UE configured with Δf=0.37 kHz (that is, for a frame structure corresponding to the last row), a black part is a position used to send master system information and cannot be changed. In this case, for the UE configured with Af=0.37 kHz, subframes #1, #2, and #3 corresponding to a slot #0 are reserved by the base station for MBSFN in downlink, so that the slot #0 satisfies a condition. Similarly, subframes corresponding to a slot #1 to a slot #12 are also reserved by the base station for a downlink MBMS, so that the slot #1 to the slot #12 also satisfy the condition.

As shown in FIG. 12B, a base station configures an MBMS dedicated carrier, configures a subframe #0 as a non-MBSFN subframe, and configures that there is an additional non-MBSFN subframe after the subframe #0 (where for example, a value of radioFrameAllocationperiod is configured as rf4, a value of radioFrameAllocationOffset is configured as 2, and a bit string configured for subframeAllocation is 001010000). It can be learned from the foregoing configuration parameters and with reference to the foregoing figure that the base station configures non-MBSFN subframes in a radio frame #N+1, and configures subframes #13 and #15 in the radio frame #N+1 as non-MBSFN subframes.

Therefore, for UE configured with Af=0.37 kHz (that is, for a frame structure corresponding to the last row), for a slot #6, because the subframes #13 and #15 corresponding to the slot #6 are configured as non-MBSFN subframes, the slot #6 does not satisfy a condition for valid slots, that is, the slot #6 is invalid for an MBMS. A method for determining whether another slot is valid is the same as that described above, and details are not described herein again.

In addition, after Δf=0.37 kHz is introduced, the following changes may be brought:

For each codeword q, a bit block

$${b}^{( q )} ( 0 ) , … , {b}^{( q )} ( {M}_{bit}^{( q )} - 1 )$$

(where

$${M}_{bit}^{( q )}$$

identifies a quantity of bits in the codeword q transmitted on a physical channel in a subframe/slot/sub-slot) needs to be scrambled according to the following formula before modulation to generate a scrambled bit block

$${\tilde{b}}^{( q )} ( 0 ) , … , {\tilde{b}}^{( q )} ( {M}_{bit}^{( q )} - 1 ) : {\tilde{b}}^{( q )} ( i ) = ( {b}_{( i )}^{( q )} + {c}_{( i )}^{( q )} ) mod 2.$$

The scrambling sequence c^{(q)}(i) is used to initialize a scrambling code sequence generator at a start moment of each subframe or slot, and an initialization value cₕᵢ: is determined based on a specific transmission channel type:

$${c}_{init} \{ \begin{matrix}{n}_{RNTI} \cdot {2}^{14} + q \cdot {2}^{13} + ⌊ {n}_{s} / 2 ⌋ \cdot {2}^{9} + {N}_{ID}^{cell} & for PDSCH \\ ⌊ {n}_{s} / 2 ⌋ \cdot {2}^{9} + {N}_{ID}^{MBSFN} & for PMCH\end{matrix} .$$

n_{RNTI} corresponds to an RNTI related to PDSCH transmission.

In addition, as described above, different subcarrier spacings correspond to different slot sizes. For example, a slot size corresponding to Δf=1.25/2.5/7.5/15 kHz is 1 ms, and a slot size corresponding to Δf=0.37 kHz is 3 ms. Therefore, in the foregoing formula, to avoid slot ambiguity, slot granularities used for determining slot numbers under different subcarrier spacings need to be described in a protocol: (1) When a subcarrier spacing is 0.37 kHz, slot numbers are determined at a slot granularity of 3 ms. In a start 40-ms interval that satisfies a condition n_{f} mod 4=0, there are 13 slots in total, where the 13 slots are numbered in ascending order from 0 to 12, and a position of a slot 0 in the 40-ms interval starts from 30720 Tₛ. n_{f} is a radio frame number, and Tₛ is a basic time unit.

(2) When a subcarrier spacing is 1.25 kHz, numbering is performed at a slot granularity of 1 ms. (3) When a subcarrier spacing is 2.5/7.5/15 kHz, numbering is performed at a slot granularity of 0.5 ms.

In addition, when the subcarrier spacing is 0.37 kHz, there are two reference signal (reference signal, RS) mapping patterns (pattern). One pattern (pattern) corresponds to a periodicity of two symbols (symbol), and the other pattern (pattern) corresponds to a periodicity of four symbols. The two reference signal mapping patterns are shown in FIG. 12C and FIG. 12D.

In addition, when the subcarrier spacing is 0.37 kHz, it may be understood that a symbol is equivalent to a slot. Therefore, if slot numbers are periodically repeated from 0 to 12(where there are 13 slots in total) when the subcarrier spacing is 0.37 kHz, because 13 is neither a multiple of 2 nor a multiple of 4, a problem of misalignment exists in the reference signal mapping pattern. Corresponding problem descriptions are shown in FIG. 12E and FIG. 12F. As identified in FIG. 12E and FIG. 12F, two adjacent slots #12 and #13 correspond to a same RS pattern, that is, a problem of misalignment exists.

Based on the foregoing problem, this embodiment of this application provides the communication method. A virtual frame is introduced in the method. In the virtual frame, numbering is performed by using 52 slots as a group, that is, slot numbers are 0 to 51. The following figure shows a virtual frame structure corresponding to the subcarrier spacing of 0.37 kHz. A length of one virtual frame is 16*10 ms=160 ms. One virtual frame includes four frames with a length of 40 ms. Each 40-ms frame includes two parts: The first millisecond in every 40 ms is used to send content such as a broadcast message and is not used for slot numbering. 39 milliseconds starting from the second millisecond to the 40th millisecond are numbered by classifying three milliseconds as one slot. One virtual frame includes 52 slots, so that slot numbers are a slot #0 to a slot #51. When a next virtual frame is entered, slot numbers start from the slot #0 again.

As shown in FIG. 12G, for a 40-ms frame numbered #0 (a black part), the first millisecond (a black part) is used to send content such as a broadcast message, and the remaining 39 milliseconds are numbered by classifying three milliseconds as one slot and correspond to a slot #0 to a slot #12. In a 40-ms frame numbered #1, the first millisecond is not used for slot numbering, and slot numbering is performed starting from the second millisecond by using numbers after the slot #12, that is, using numbers starting from a slot #13. By analogy, for a 40-ms frame numbered #3, corresponding slot numbers are from a slot #39 to a slot #51.

Resource unit mapping under the subcarrier spacing of 0.37 kHz is described as follows: A reference signal sequence r(m′) in an OFDM symbol 1 is mapped to a complex modulation symbol

$${a}_{k , l}^{( p )}$$

according to the following relationship:

$${a}_{k , l}^{( p )} = {r}_{l , {n}_{s}} ( {m}^{′} ) .$$

p=4, ns is a number of a 3-ms slot, and

$$0 \leq k < \frac{{N}_{sc}^{RB}}{12} {N}_{RB}^{DL} .$$

For an MBSFN reference signal pattern type 1:

$$k = \{ \begin{matrix}12 ( {m}^{′} - ⌊ \frac{{N}_{sc}^{RB}}{12} ⌋ Δ ) + 3 ( {n}_{s} mod 4 ) & if {n}_{s} mod 4 ∈ \{ 0 , 1 \} \\ 12 ( {m}^{′} - ⌈ \frac{{N}_{sc}^{RB}}{12} ⌉ Δ ) + 3 ( {n}_{s} mod 4 ) & if {n}_{s} mod 4 ∈ \{ 2 , 3 \}\end{matrix} ,$$

$$l = 0 ,$$

$$Δ = \frac{{N}_{RB}^{max , DL} - {N}_{RB}^{DL}}{2} , and$$

$${m}^{′} = 0 , 1 , … , \frac{{N}_{sc}^{RB}}{12} {N}_{RB}^{max , DL} - 1.$$

For an MBSFN reference signal pattern type 2:

$$k = 6 ( {m}^{′} - \frac{{N}_{sc}^{RB}}{6} Δ ) + 3 ( {n}_{s} mod 2 ) ,$$

$$l = 0 ,$$

$$Δ = \frac{{N}_{RB}^{max , DL} - {N}_{RB}^{DL}}{2} , and$$

$${m}^{′} = 0 , 1 , … , \frac{{N}_{sc}^{RB}}{6} {N}_{RB}^{max , DL} - 1.$$

In the foregoing formulas, ns may be replaced by ns′, and ns' is expressed as follows:

$${n}_{s}^{′} = [ f ( {n}_{f} / 4 ) * 13 + {n}_{s} ] mod 52 , or {n}_{s}^{′} = f ( {n}_{f} / 4 ) * 13 + {n}_{s} .$$

f ( ) is a floor function, and a function of f ( ) is “rounding down”, that is, to obtain a maximum integer not greater than x. Different from “rounding off”, rounding down is to directly obtain a value that is on the left of and that is closest to a required value on a number axis, that is, a maximum integer not greater than the required value. n_{f} is a value of a frame number of a radio frame, ns is a number of a 3-ms slot, and the number ranges from 0 to 12 in 40 ms. Specifically, in a start 40-ms interval that satisfies the condition n_{f} mod 4=0, there are 13 slots in total, where the 13 slots are numbered in ascending order from 0 to 12, and a position of a slot 0 in the 40-ms interval starts from 30720 Tₛ. n_{f} is a radio frame number, and Tₛ is a basic time unit.

In this embodiment of this application, according to the foregoing method, a terminal device can determine, in different carrier spacing configurations, a time-frequency position at which a network device sends a multicast service, to ensure that the terminal device can accurately receive the multicast service.

For Embodiment 1 to Embodiment 7, it should be noted:

(1) Embodiment 1 and Embodiment 7 may be separately implemented in different scenarios, or may be implemented in combination in a same scenario, or different solutions involved in different embodiments may be implemented in combination (where for example, some or all solutions involved in Embodiment 1 may be implemented in combination with Embodiment 6). This is not specifically limited.

(2) Step numbers in the flowcharts (for example, FIG. 5, FIG. 7A and FIG. 7B, FIG. 8, FIG. 9, and FIG. 10) described in embodiments of this application are merely examples of execution procedures, and do not constitute a limitation on execution sequences of the steps. In embodiments of this application, there is no strict execution sequence between steps that have no time sequence dependency relationship with each other.

The foregoing mainly describes the solutions provided in embodiments of this application from a perspective of interaction between a network device and a terminal device. It may be understood that, to implement the foregoing functions, the network device or the terminal device may include a corresponding hardware structure and/or a software module for performing each function. A person skilled in the art should be easily aware that, in combination with units and algorithm steps of the examples described in embodiments disclosed in this specification, embodiments of this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, division into function units may be performed on the terminal device and the network device based on the foregoing method examples. For example, division into each function unit may be based on each corresponding function, or two or more functions may be integrated into one unit. The integrated unit may be implemented in a form of hardware, or may be implemented in a form of a software function unit.

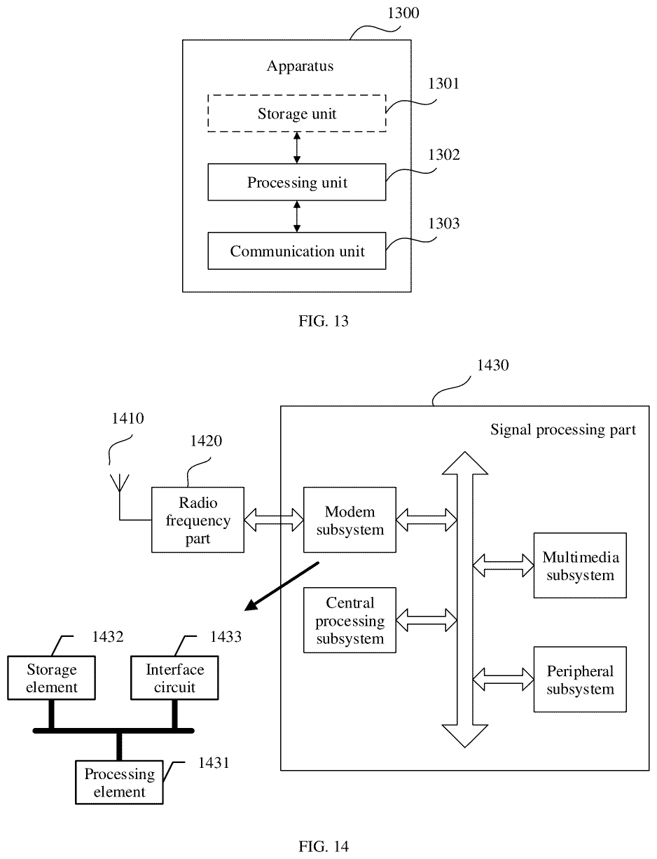

When an integrated unit is used, FIG. 13 is a possible example block diagram of an apparatus according to an embodiment of this application. As shown in FIG. 13, the apparatus 1300 may include a processing unit 1302 and a communication unit 1303. The processing unit 1302 is configured to control and manage an action of the apparatus 1300. The communication unit 1303 is configured to support the apparatus 1300 in communicating with another device. Optionally, the communication unit 1303 is also referred to as a transceiver unit, and may include a receiving unit and/or a sending unit, respectively configured to perform a receiving operation and a sending operation. The apparatus 1300 may further include a storage unit 1301, configured to store program code and/or data of the apparatus 1300.

The apparatus 1300 may be the terminal device in any one of the foregoing embodiments, or may be a chip disposed in the terminal device. The processing unit 1302 may support the apparatus 1300 in performing actions of the terminal device in the foregoing method examples. Alternatively, the processing unit 1302 mainly performs an internal action of the terminal device in the method examples, and the communication unit 1303 may support communication between the apparatus 1300 and a network device. For example, the communication unit 1303 may be configured to perform step 502, step 504, step 506, and step 508 in FIG. 5; step 702, step 702a, step 704, step 704a, and step 708 in FIG. 7A and FIG. 7B; step 802, step 804, step 806, step 808, step 809, and step 811 in FIG. 8; step 902, step 904, and step 906 in FIG. 9; and step 1001, step 1004, step 1007, step 1008, and step 1010 in FIG. 10. The processing unit 1302 may be configured to perform step 505 in FIG. 5, step 705 in FIG. 7A, step 905 in FIG. 9, and step 1009 in FIG. 10.

In a possible design, the first multicast configuration information further includes a group radio network temporary identifier G-RNTI and/or a multicast service identifier that are/is associated with the first multicast service, and the G-RNTI and/or the multicast service identifier are/is associated with the first indication information.

In a possible design, the first indication information indicates, by using a bit or a field, to provide a feedback for the first multicast service; and/or the first indication information is for indicating a transmission resource of the first feedback information.

In a possible design, the first indication information includes a signal quality parameter threshold; and when a value of a signal quality parameter corresponding to the first multicast service is less than or equal to the threshold, the communication unit 1303 sends the first feedback information to the network device.

In a possible design, the communication unit 1303 is further configured to receive second multicast configuration information from the network device, where the second multicast configuration information corresponds to a second multicast service, the second multicast configuration information includes second indication information, and the second indication information is for indicating that the terminal device does not need to send feedback information for the second multicast service.

In a possible design, the communication unit 1303 is further configured to send the first feedback information corresponding to the first multicast service and/or second feedback information corresponding to a unicast service to the network device based on a priority of the feedback information.

In a possible design, the priority of the feedback information is determined based on third indication information, and the third indication information is from the network device; or the priority of the feedback information is predefined.

In a possible design, the third indication information is carried in DCI, and the DCI is for scheduling a physical downlink shared channel PDSCH that carries the first multicast service; or the third indication information is carried in a radio resource control RRC message.

In a possible design, the communication unit 1303 is further configured to send feedback stopping acknowledgment information to the network device, where the feedback stopping acknowledgment information is for indicating that sending of the feedback information for the first multicast service is stopped.

In a possible design, the communication unit 1303 is further configured to send the feedback stopping acknowledgment information to the network device based on a predefined parameter or fourth indication information that is from the network device, where the fourth indication information is for triggering the terminal device to send the feedback stopping acknowledgment information to the network device.

In a possible design, the feedback stopping acknowledgment information is indicated by a logical channel identifier LCID, and the LCID is carried in a media access control MAC subheader; or the feedback stopping acknowledgment information is indicated by fifth indication information in a MAC control element CE; or the feedback stopping acknowledgment information is indicated by a length of a MAC CE.

In a possible design, the communication unit 1303 is further configured to send feedback capability information to the network device, where the feedback capability information is for indicating a capability of sending unicast feedback information and multicast feedback information on a same feedback resource, the unicast feedback information is feedback information corresponding to a unicast service, and the multicast feedback information is feedback information corresponding to a multicast service.

The apparatus 1300 may be the network device in any one of the foregoing embodiments, or may be a chip disposed in the network device. The processing unit 1302 may support the apparatus 1300 in performing actions of the network device in the foregoing method examples. Alternatively, the processing unit 1302 mainly performs an internal action of the network device in the method examples, and the communication unit 1303 may support communication between the apparatus 1300 and a terminal device. For example, the communication unit 1303 may be configured to perform step 501, step 503, and step 507 in FIG. 5; step 701, step 701a, step 701b, step 703, and step 707 in FIG. 7A and FIG. 7B; step 801, step 803, step 805, step 807, and step 810 in FIG. 8; step 901 and step 903 in FIG. 9; and step 1002, step 1003, step 1005, and step 1006 in FIG. 10. The processing unit 1302 may be configured to perform step 1002 in FIG. 10.

In a possible design, the first multicast configuration information further includes a group radio network temporary identifier G-RNTI and/or a multicast service identifier that are/is associated with the first multicast service, and the G-RNTI and/or the multicast service identifier are/is associated with the first indication information.

In a possible design, the first indication information indicates, by using a bit or a field, to provide a feedback for the first multicast service; and/or the first indication information is for indicating a transmission resource of the first feedback information.

In a possible design, the first indication information includes a signal quality parameter threshold.

In a possible design, before the communication unit 1303 sends the first multicast configuration information to the terminal device, the processing unit 202 is configured to determine, based on at least one of a service requirement of the first multicast service, a physical relative distance between the terminal device and the network device, and channel quality of the terminal device, the terminal device that needs to send the feedback information for the first multicast service.

In a possible design, the communication unit 1303 is further configured to send second multicast configuration information to the terminal device, where the second multicast configuration information corresponds to a second multicast service, the second multicast configuration information includes second indication information, and the second indication information is for indicating that the terminal device does not need to send feedback information for the second multicast service.

In a possible design, before receiving the first feedback information from the terminal device, the communication unit 1303 is further configured to send third indication information to the terminal device, where the third indication information is for indicating a priority of the feedback information of the first multicast service.

In a possible design, the third indication information is carried in downlink control information DCI, and the DCI is for scheduling a physical downlink shared channel PDSCH that carries the first multicast service.

In a possible design, the communication unit 1303 is configured to: send fourth indication information to the terminal device, where the fourth indication information is for indicating the terminal device to stop sending the feedback information for the first multicast service; and receive feedback stopping acknowledgment information from the terminal device, where the feedback stopping acknowledgment information is for indicating that the terminal device stops sending the feedback information for the first multicast service.

In a possible design, the feedback stopping acknowledgment information is indicated by a logical channel identifier LCID, and the LCID is carried in a media access control MAC subheader; or the feedback stopping acknowledgment information is indicated by fifth indication information in a MAC control element CE; or the feedback stopping acknowledgment information is indicated by a length of a MAC CE.

In a possible design, the communication unit 1303 is further configured to receive feedback capability information from the terminal device, where the feedback capability information is for indicating a capability of sending unicast feedback information and multicast feedback information on a same feedback resource by the terminal device, the unicast feedback information is feedback information corresponding to a unicast service, and the multicast feedback information is feedback information corresponding to a multicast service.

It should be understood that division into the units in the foregoing apparatus is merely logical function division. During actual implementation, all or some of the units may be integrated into one physical entity, or may be physically separated. In addition, all the units in the apparatus may be implemented in a form of software invoked by a processing element, or may be implemented in a form of hardware; or some units may be implemented in a form of software invoked by a processing element, and some units may be implemented in a form of hardware. For example, each unit may be an independently disposed processing element, or may be integrated into a chip of the apparatus for implementation. Alternatively, each unit may be stored in a memory in a form of a program to be invoked by a processing element of the apparatus to perform a function of the unit. In addition, all or some of the units may be integrated together, or may be implemented independently. The processing element herein may also be referred to as a processor, and may be an integrated circuit having a signal processing capability. In an implementation process, the steps in the foregoing methods or the foregoing units may be implemented by using a hardware integrated logic circuit in the processing element, or may be implemented in a form of software invoked by the processing element.

In an example, the unit in any one of the foregoing apparatuses may be one or more integrated circuits configured to implement the foregoing methods, for example, one or more application-specific integrated circuits (Application-Specific Integrated Circuits, ASICs), or one or more microprocessors (digital signal processors, DSPs), or one or more field programmable gate arrays (Field Programmable Gate Arrays, FPGAs), or a combination of at least two of these integrated circuit forms. For another example, when the unit in the apparatus is implemented by scheduling a program by a processing element, the processing element may be a processor, for example, a central processing unit (central processing unit, CPU) or another processor that can invoke the program. For another example, the units may be integrated and implemented in a form of a system-on-a-chip (system-on-a-chip, SoC).

The foregoing receiving unit is an interface circuit of the apparatus, and is configured to receive a signal from another apparatus. For example, when the apparatus is implemented by a chip, the receiving unit is an interface circuit that is of the chip and that is configured to receive a signal from another chip or apparatus. The foregoing sending unit is an interface circuit of the apparatus, and is configured to send a signal to another apparatus. For example, when the apparatus is implemented by a chip, the sending unit is an interface circuit that is of the chip and that is configured to send a signal to another chip or apparatus.

FIG. 14 is a schematic diagram of a structure of a terminal device according to an embodiment of this application. The terminal device may be the terminal device in the foregoing embodiments, and may be configured to implement operations of the terminal device in the foregoing embodiments. As shown in FIG. 14, the terminal device includes an antenna 1410, a radio frequency part 1420, and a signal processing part 1430. The antenna 1410 is connected to the radio frequency part 1420. In a downlink direction, the radio frequency part 1420 receives, through the antenna 1410, information sent by a network device, and sends, to the signal processing part 1430 for processing, the information sent by the network device. In an uplink direction, the signal processing part 1430 processes information of the terminal device, and sends the information to the radio frequency part 1420. The radio frequency part 1420 processes the information of the terminal device, and then sends the processed information to the network device through the antenna 1410.

The signal processing part 1430 may include a modem subsystem, configured to process data at each communication protocol layer. The signal processing part 1430 may further include a central processing subsystem, configured to implement processing of an operating system and an application layer of the terminal device. In addition, the signal processing part 1430 may further include another subsystem, for example, a multimedia subsystem or a peripheral subsystem. The multimedia subsystem is configured to control a camera, a screen display, or the like of the terminal device, and the peripheral subsystem is configured to implement a connection to another device. The modem subsystem may be a chip that is separately disposed.

The modem subsystem may include one or more processing elements 1431, for example, include one main control CPU and another integrated circuit. In addition, the modem subsystem may further include a storage element 1432 and an interface circuit 1433. The storage element 1432 is configured to store data and a program. However, a program used to perform the method performed by the terminal device in the foregoing methods may not be stored in the storage element 1432, but is stored in a memory outside the modem subsystem, and is loaded and used by the modem subsystem when to be used. The interface circuit 1433 is configured to communicate with another subsystem.

The modem subsystem may be implemented by a chip. The chip includes at least one processing element and an interface circuit. The processing element is configured to perform the steps in any one of the methods performed by the terminal device. The interface circuit is configured to communicate with another apparatus. In an implementation, units in the terminal device for implementing the steps in the foregoing methods may be implemented by scheduling a program by a processing element. For example, an apparatus used in the terminal device includes a processing element and a storage element. The processing element invokes a program stored in the storage element, to perform the method performed by the terminal device in the foregoing method embodiments. The storage element may be a storage element located on a same chip as the processing element, that is, an on-chip storage element.

In another implementation, a program used to perform the method performed by the terminal device in the foregoing methods may be in a storage element located on a different chip from the processing element, that is, an off-chip storage element. In this case, the processing element invokes or loads the program from the off-chip storage element to an on-chip storage element, to invoke and perform the method performed by the terminal device in the foregoing method embodiments.

In still another implementation, units in the terminal device for implementing the steps in the foregoing methods may be configured as one or more processing elements. The processing elements are disposed in the modem subsystem. The processing element herein may be an integrated circuit, for example, one or more ASICs, one or more DSPs, one or more FPGAs, or a combination of these types of integrated circuits. These integrated circuits may be integrated to form a chip.

Units in the terminal device for implementing the steps in the foregoing methods may be integrated together, and implemented in a form of a SoC. The SoC chip is configured to implement the foregoing methods. At least one processing element and storage element may be integrated into the chip, and the processing element invokes a program stored in the storage element to implement the foregoing method performed by the terminal device. Alternatively, at least one integrated circuit may be integrated into the chip, to implement the foregoing methods performed by the terminal device. Alternatively, with reference to the foregoing implementations, functions of some units may be implemented by invoking a program by the processing element, and functions of some units may be implemented by the integrated circuit.

It can be learned that the foregoing apparatus used in the terminal device may include at least one processing element and an interface circuit. The at least one processing element is configured to perform any one of the methods that are provided in the foregoing method embodiments and performed by the terminal device. The processing element may perform some or all steps performed by the terminal device in a first manner, to be specific, by invoking the program stored in the storage element; or may perform some or all steps performed by the terminal device in a second manner, to be specific, by using a hardware integrated logic circuit in the processing element in combination with instructions; or may certainly perform, by combining the first manner and the second manner, some or all steps performed by the terminal device.

The processing element herein is the same as that described above, and may be implemented by using a processor. A function of the processing element may be the same as a function of the processing unit described in FIG. 13. For example, the processing element may be a general-purpose processor, for example, a CPU, or may be one or more integrated circuits configured to implement the foregoing methods, for example, one or more ASICs, one or more microprocessors DSPs, one or more FPGAs, or a combination of at least two of the integrated circuit forms. The storage element may be implemented by using a memory. A function of the storage element may be the same as a function of the storage unit described in FIG. 14. The storage element may be implemented by using a memory. A function of the storage element may be the same as a function of the storage unit described in FIG. 14. The storage element may be one memory, or an umbrella term of a plurality of memories.

The terminal device shown in FIG. 14 can implement the processes related to the terminal device in the method embodiment shown in FIG. 5, FIG. 7A and FIG. 7B, or FIG. 8. Operations and/or functions of the modules in the terminal device shown in FIG. 14 are intended to implement the corresponding procedures in the foregoing method embodiments. For details, refer to the descriptions in the foregoing method embodiments. To avoid repetition, detailed descriptions are properly omitted herein.

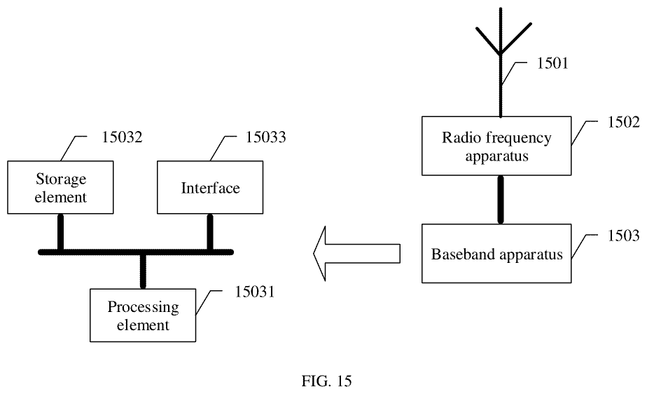

FIG. 15 is a schematic diagram of a structure of a network device according to an embodiment of this application. The network device is configured to implement operations of the network device in the foregoing embodiments. As shown in FIG. 15, the network device includes an antenna 1501, a radio frequency apparatus 1502, and a baseband apparatus 1503. The antenna 1501 is connected to the radio frequency apparatus 1502. In an uplink direction, the radio frequency apparatus 1502 receives, through the antenna 1501, information sent by a terminal device, and sends, to the baseband apparatus 1503 for processing, the information sent by the terminal device. In a downlink direction, the baseband apparatus 1503 processes information of the terminal device, and sends the information to the radio frequency apparatus 1502. The radio frequency apparatus 1502 processes the information of the terminal device, and then sends the processed information to the terminal device through the antenna 1501.

The baseband apparatus 1503 may include one or more processing elements 15031, for example, include one main control CPU and another integrated circuit. In addition, the baseband apparatus 1503 may further include a storage element 15032 and an interface 15033. The storage element 15032 is configured to store a program and data. The interface 15033 is configured to exchange information with the radio frequency apparatus 1502, and the interface is, for example, a common public radio interface (common public radio interface, CPRI). The foregoing apparatus used in the network device may be located in the baseband apparatus 1503. For example, the foregoing apparatus used in the network device may be a chip on the baseband apparatus 1503. The chip includes at least one processing element and an interface circuit. The processing element is configured to perform the steps in any one of the methods performed by the network device. The interface circuit is configured to communicate with another apparatus. In an implementation, units in the network device for implementing the steps in the foregoing methods may be implemented by scheduling a program by a processing element. For example, the apparatus used in the network device includes a processing element and a storage element. The processing element invokes a program stored in the storage element, to perform the method performed by the network device in the foregoing method embodiments. The storage element may be a storage element that is located on a same chip as the processing element, that is, an on-chip storage element, or may be a storage element that is located on a different chip from the processing element, that is, an off-chip storage element.

In another implementation, units in the network device for implementing the steps in the foregoing methods may be configured as one or more processing elements. The processing elements are disposed in the baseband apparatus. The processing element herein may be an integrated circuit, for example, one or more ASICs, one or more DSPs, one or more FPGAs, or a combination of these types of integrated circuits. These integrated circuits may be integrated to form a chip.

Units in the network device for implementing the steps in the foregoing methods may be integrated together, and implemented in a form of a system-on-a-chip (system-on-a-chip, SoC). For example, the baseband apparatus includes the SoC chip, configured to implement the foregoing methods. At least one processing element and storage element may be integrated into the chip, and the processing element invokes a program stored in the storage element to implement the foregoing method performed by the network device. Alternatively, at least one integrated circuit may be integrated into the chip, to implement the foregoing methods performed by the network device. Alternatively, with reference to the foregoing implementations, functions of some units may be implemented by invoking a program by the processing element, and functions of some units may be implemented by the integrated circuit.

It can be learned that the foregoing apparatus used in the network device may include at least one processing element and an interface circuit. The at least one processing element is configured to perform any one of the methods that are provided in the foregoing method embodiments and performed by the network device. The processing element may perform some or all steps performed by the network device in a first manner, to be specific, by invoking the program stored in the storage element; or may perform some or all steps performed by the network device in a second manner, to be specific, by using a hardware integrated logic circuit in the processing element in combination with instructions; or may certainly perform, by combining the first manner and the second manner, some or all steps performed by the network device.

The processing element herein is the same as that described above, and may be implemented by using a processor. A function of the processing element may be the same as a function of the processing unit described in FIG. 10. For example, the processing element may be a general-purpose processor, for example, a CPU, or may be one or more integrated circuits configured to implement the foregoing methods, for example, one or more ASICs, one or more microprocessors DSPs, one or more FPGAs, or a combination of at least two of the integrated circuit forms. The storage element may be implemented by using a memory. A function of the storage element may be the same as a function of the storage unit described in FIG. 12. The storage element may be implemented by using a memory. A function of the storage element may be the same as a function of the storage unit described in FIG. 10. The storage element may be one memory, or an umbrella term of a plurality of memories.

The network device shown in FIG. 14 can implement the processes related to the network device in the method embodiments shown in FIG. 5, and FIG. 7A to FIG. 10. Operations and/or functions of the modules in the network device shown in FIG. 14 are intended to implement the corresponding procedures in the foregoing method embodiments. For details, refer to the descriptions in the foregoing method embodiments. To avoid repetition, detailed descriptions are properly omitted herein.

A person skilled in the art should understand that embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specified function in one or more processes in the flowcharts and/or in one or more blocks in the block diagrams.

These computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specified function in one or more processes in the flowcharts and/or in one or more blocks in the block diagrams.

These computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specified function in one or more processes in the flowcharts and/or in one or more blocks in the block diagrams.

Clearly, a person skilled in the art can make various modifications and variations to this application without departing from the spirit and scope of this application. In this way, this application is intended to cover these modifications and variations of this application provided that they fall within the scope of the claims of this application and their equivalent technologies.

What is claimed is:

1. A communication method, wherein the method is applicable to a terminal device or a chip of the terminal device, and comprises:
receiving first multicast configuration information, wherein the first multicast configuration information includes first indication information indicating to send first feedback information for the first multicast service;
receiving the first multicast service;
sending first feedback information.

2. The method according to claim 1, wherein the first multicast configuration information carried in a radio resource control (RRC) message.

3. The method according to claim 1, wherein the first multicast configuration information further comprises at least one of the following:
a group radio network temporary identifier (G-RNTI);
a multicast service identifier;
bandwidth part (BWP) information corresponding to the G-RNTI;
a physical downlink shared channel (PDSCH) scrambling sequence of a multicast service;
a discontinuous reception (DRX) parameter of the G-RNTI; or
a radio bearer identifier.

4. The method according to claim 3, wherein the BWP information corresponding to the G-RNTI comprises at least one of the following:
a bandwidth, a frequency position, configuration information related to a control resource set (CORESET), or configuration information related to a PDSCH.

5. The method according to claim 1, wherein the first indication information is indicated by at least one bit or at least one special field.

6. The method according to claim 1, wherein the method further comprises:
determining, based on fourth indication information, to stop sending the feedback information for the first multicast service, wherein the fourth indication information indicates to stop sending the feedback information.

7. The method according to claim 1, wherein the method further comprises:
sending feedback capability information, where the feedback capability information is for indicating a capability of sending unicast feedback information and multicast feedback information on a same feedback resource, wherein the unicast feedback information is feedback information of unicast service, and the multicast feedback information is feedback information of multicast service.

8. A communication method, wherein the method is applicable to a network device or a chip of the network device, and comprises:
sending first multicast configuration information, wherein the first multicast configuration information includes first indication information indicating to send first feedback information for the first multicast service;
sending the first multicast service;
receiving first feedback information.

9. The method according to claim 8, wherein the first multicast configuration information carried in a radio resource control (RRC) message.

10. The method according to claim 8, wherein the first multicast configuration information further comprises at least one of the following:
a group radio network temporary identifier (G-RNTI);
a multicast service identifier;
bandwidth part (BWP) information corresponding to the G-RNTI;
a physical downlink shared channel (PDSCH) scrambling sequence of a multicast service;
a discontinuous reception (DRX) parameter of the G-RNTI; or
a radio bearer identifier.

11. The method according to claim 10, wherein the BWP information corresponding to the G-RNTI comprises at least one of the following:
a bandwidth, a frequency position, configuration information related to a control resource set (CORESET), or configuration information related to a PDSCH.

12. The method according to claim 8, wherein the first indication information is indicated by at least one bit or at least one special field.

13. The method according to claim 8, wherein the method further comprises:
sending, based on fourth indication information, to stop sending the feedback information for the first multicast service, wherein the fourth indication information indicates to stop sending the feedback information.

14. The method according to claim 8, wherein the method further comprises:
receiving feedback capability information, where the feedback capability information is for indicating a capability of sending unicast feedback information and multicast feedback information on a same feedback resource, wherein the unicast feedback information is feedback information of unicast service, and the multicast feedback information is feedback information of multicast service.

15. An apparatus, comprising:
a memory storing instructions; and
at least one processor in communication with the memory, the at least one processor configured, upon execution of the instructions, to perform the following steps:
receive first multicast configuration information, wherein the first multicast configuration information includes first indication information indicating to send first feedback information for the first multicast service;
receive the first multicast service;
send first feedback information.

16. The apparatus according to claim 15, wherein the first multicast configuration information carried in a radio resource control (RRC) message.

17. The apparatus according to claim 15, wherein the first multicast configuration information further comprises at least one of the following:
a group radio network temporary identifier (G-RNTI);
a multicast service identifier;
bandwidth part (BWP) information corresponding to the G-RNTI;
a physical downlink shared channel (PDSCH) scrambling sequence of a multicast service;
a discontinuous reception (DRX) parameter of the G-RNTI; or
a radio bearer identifier.

18. The apparatus according to claim 17, wherein the BWP information corresponding to the G-RNTI comprises at least one of the following:
a bandwidth, a frequency position, configuration information related to a control resource set (control resource set, CORESET), or configuration information related to a PDSCH.

19. The apparatus according to claim 15, wherein the first indication information is indicated by at least one bit or at least one special field.

20. The apparatus according to claim 15, wherein the apparatus is further caused to perform:
determining, based on fourth indication information, to stop sending the feedback information for the first multicast service, wherein the fourth indication information indicates to stop sending the feedback information.
